(19) United States
(12) Patent Application Publication
(10) Pub. No.: US 2011/0238820 A1
(43) Pub. Date: Sep. 29, 2011

(54) COMPUTER, COMMUNICATION DEVICE, AND COMMUNICATION CONTROL SYSTEM

(75) Inventor: Naoki MATSUOKA, Kawasaki (JP)

(73) Assignee: FUJITSU LIMITED, Kawasaki-shi (JP)

(21) Appl. No.: 13/041,325

(22) Filed: Mar. 4, 2011

(30) Foreign Application Priority Data
Mar. 23, 2010 (JP) 2010-066934

(51) Int. Cl. G06F 15/173

(52) U.S. Cl. 709/224

(57) ABSTRACT

A physical server monitors a state of a virtual machine that runs on the server. When it is detected that the state of the virtual machine is changed, the physical server transmits information indicating the state change of the virtual machine to a physical switch accommodating the server and controlling communication between the server or the virtual machine and another device or another virtual machine. The physical switch stores configuration information of the virtual machine that runs on an information processing device accommodated by the server. When the physical switch receives the information indicating the state change of the virtual machine from the physical server, the physical switch updates the configuration information based on the received information. The physical switch controls the communication between the physical server or the virtual machine and another device or another virtual machine, based on the stored configuration information.

### CROSS-REFERENCE TO RELATED APPLICATION

This application is based upon and claims the benefit of priority of the prior Japanese Patent Application No. 2010-066934, filed on Mar. 23, 2010, the entire contents of which are incorporated herein by reference.

### FIELD

The embodiments discussed herein are directed to a communication control system.

### BACKGROUND

In recent years, cloud computing (hereinafter, referred to as cloud environment) that can use plural computing resources on a network as computing resources of users using a virtualization technique of a server or the network has attracted attention.

In the cloud environment, since users belonging to different companies or sections generally share a server, it is needed to definitely separate resources of a virtual machine (VM) and resources of a network (NW) from each other. Therefore, in the cloud environment, a VM management server that manages the VM and an NW management server that manages an NW device such as a switch independently exist.

Specifically, since the VM management server can recognize only information of the VM under management of a self device, the VM management server cannot recognize information of the NW device that is not under the management of the self device. That is, the VM management server cannot recognize a type and setting information of the NW device that exists on the network. Likewise, the NW management server can recognize only the information of the NW device under management of the self device and cannot recognize the information of the VM that is not under the management of the self device. That is, the NW management server cannot recognize which VM is executed in each server.

In the cloud environment, since the users belonging to the different companies or sections share the server, a method that raises security with respect to each user is executed. For example, access restriction for each user based on a virtual local area network (ULAN) or an access control list (ACL) or quality of service (QoS) control to secure a use band for each user is executed.

In this cloud environment, migration control to move the VM executed on a server to another server is also executed. In this case, the migration control in the cloud environment will be described using FIG. 22. FIG. 22 illustrates an example of live migration in the cloud environment in the related art.

As illustrated in FIG. 22, the cloud environment has a VM management server, a physical server A, a physical switch A, a physical server B, a physical switch B, and an NW management server. The VM management server holds information of a VM executed in each of the physical server A and the physical server B, and the NW management server holds configuration information related to a VM set to each of the physical switch A and the physical switch B. The VM management server and the NW management server do not cooperate with each other, because sections or companies managed by the VM management server and the NW management server are different from each other.

In addition, a VM1 and a VM2 are executed on the physical server A, and configuration information related to the VM1 and the VM2 is set to the physical switch A connected to the physical server A. A VM3 is executed on the physical server B, and configuration information related to the VM3 is set to the physical switch B connected to the physical server B.

In this situation, an example of the case where the VM2 on the physical server A is live migrated to the physical server B will be described. First, the VM management server transmits a live migration instruction of the VM2 to the physical server A (refer to (α) of FIG. 22). The management server A that receives the live migration instruction live migrates the VM2 to the physical server B (refer to (β) of FIG. 22).

Then, if the physical server B detects that the live migration of the VM2 is completed, the physical server B transmits a gratuitous address resolution protocol (GARP) packet to the physical switch B connected to the physical server B (refer to (γ) of FIG. 22). Then, the physical switch B transmits a configuration information acquisition request of the VM2 to the NW management server (refer to (δ) of FIG. 22). The NW management server that receives the configuration information acquisition request of the VM2 transmits configuration information of the VM2 to the physical switch B of the movement destination and transmits a deletion instruction of the configuration information of the VM2 to the physical switch A of the movement source (refer to (ε) of FIG. 22). As a result, the VM2 moves to the physical server B, the configuration information of the VM2 is set to the physical switch B to which the physical server B is connected, and the live migration is completed. For example, Japanese Laid-open Patent Publication No. 2009-217474 and Japanese Laid-open Patent Publication No. 2009-181418 disclose the related arts as above.

However, in the related art, the moved virtual machine may not perform communication, in spite of the migration being completed.

Specifically, the moved virtual machine cannot perform communication until a configuration is set to the physical switch to which the server of the movement destination is connected. For example, in the case of FIG. 22, the VM2 cannot perform communication until the physical server B transmits the GARP packet and the physical switch B receives the configuration of the VM2 from the NW management server and completes (activates) the setting.

Even though the correct configuration setting of the VM2 is given in the physical switch B of the movement destination, when the configuration setting of the VM2 is not deleted by the physical switch A of the movement source, the same configuration setting is given to the two physical switches. In this case, a packet that is to be transmitted to the VM2 of the physical server B through the physical switch B may be transmitted from the physical switch A to the physical server A where the VM2 does not exist. That is, the packet may not be transmitted to the VM2.

A method that previously sets configuration of a VM as a movement object to a physical switch to which a physical server of the movement destination is connected is also considered. However, as described above, in the cloud environment, the VM management server and the NW management server are generally managed by the different companies and do not cooperate with each other. Therefore, it is difficult to share a relationship of each server and migration of each VM executed in each server, between the management companies of both servers. In particular, in the case where the cloud environment is a large-scale cloud environment or the frequent migration of VM is generated, it is difficult to share information related to the migration, and a manpower load is large. For this reason, the method that previously sets the configuration of the VM as the movement object is unrealistic.

### SUMMARY

According to an aspect of an embodiment of the invention, a computer includes a monitoring unit that monitors a state of a virtual machine running on the computer; and a state transmitting unit that transmits, in response to detection of a change in the state of the virtual machine, information including a content of the state change of the virtual machine to a communication device to control communication between the computer and another computer.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating the entire configuration of a network according to a first embodiment;

FIG. 2 is a block diagram illustrating the configuration of a physical server and a physical switch according to the first embodiment;

FIG. 3 is a diagram illustrating an example of information that is stored in a VM information DB;

FIG. 4 is a diagram illustrating an example of the case where a record is added to the VM information DB;

FIG. 5 is a diagram illustrating an example of a VM information notification message;

FIG. 6 is a diagram illustrating an example of information that is stored in a configuration information DB;

FIG. 7 is a diagram illustrating an example of the case where a VM2 of a physical server A is live migrated to a physical server B;

FIG. 8 is a diagram illustrating an operation sequence of a system according to the first embodiment;

FIG. 9 is a flowchart illustrating a flow of a VM monitoring process;

FIG. 10 is a flowchart illustrating a flow of an event notifying process;

FIG. 11 is a flowchart illustrating a flow of a VM information receiving process;

FIG. 12 is a diagram illustrating an operation sequence when a VM is newly run in a system according to a second embodiment;

FIG. 13 is a diagram illustrating an operation sequence when the VM is paused in the system according to the second embodiment;

FIG. 14 is a diagram illustrating an example of a group management DB in which configuration information is grouped and stored by a physical switch according to a third embodiment;

FIG. 15 is a flowchart illustrating a flow of a VM information receiving process that is executed by the physical switch according to the third embodiment;

FIG. 16 is a diagram illustrating another example of the group management DB in which the configuration information according to the third embodiment is grouped and stored;

FIG. 17 is a flowchart illustrating a flow of a VM monitoring process according to a fourth embodiment;

FIG. 18 is a diagram illustrating an operation sequence when a VM is newly run in a system according to a fifth embodiment;

FIG. 19 is a diagram illustrating an operation sequence when the VM is migrated in the system according to the fifth embodiment;

FIG. 20 is a flowchart illustrating a flow of a VM information receiving process according to the fifth embodiment;

FIG. 21 is a diagram illustrating an example of the case where live migration is executed in a network in which physical switches are configured in multi-steps; and

FIG. 22 is a diagram illustrating an example of live migration in a cloud environment in the related art.

### DESCRIPTION OF EMBODIMENTS

Preferred embodiments of the present invention will be explained with reference to accompanying drawings. However, the present invention is not limited by the embodiments.

### [a ] First Embodiment

Entire Configuration

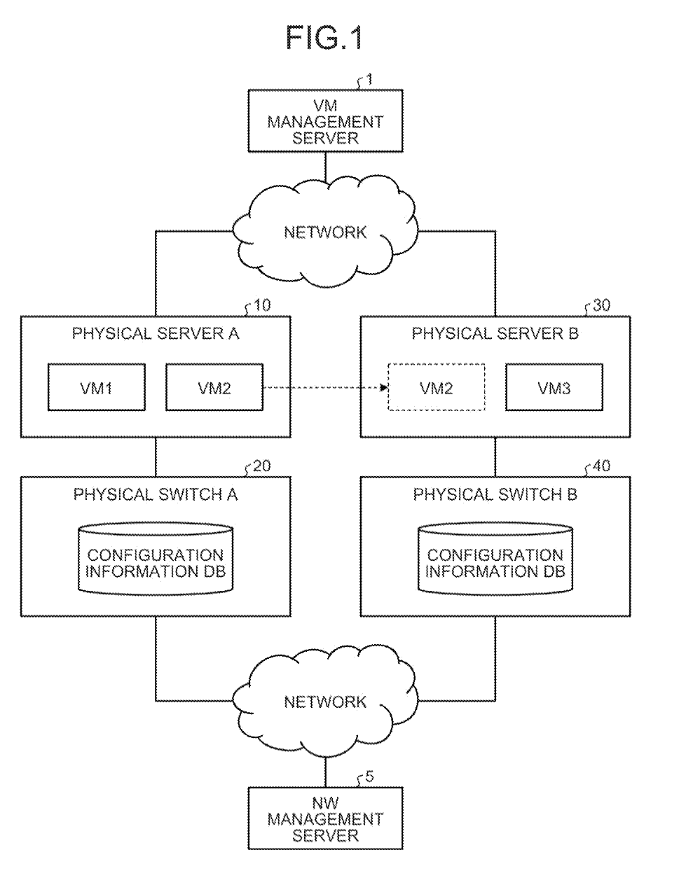

FIG. 1 illustrates the entire configuration of a network according to a first embodiment. As illustrated in FIG. 1, in the network, a virtual machine (VM) management server 1, a network (NW) management server 5, a physical server A 10, a physical switch A 20, a physical server B 30, and a physical switch B 40 are connected to communicate with each other. The VM management server 1 and the NW management server 5 are managed by different management companies and do not cooperate with each other. The number of each of physical servers or physical switches is not limited to the above example.

The VM management server 1 is an information processing apparatus that is connected to each of the physical server A 10 and the physical server B 30 through the network such as the Internet and manages a virtual machine (VM) executed on the physical server A 10 or the physical server B 30. For example, the VM management server 1 receives an instruction operation from an administrator or the like and transmits a new VM running instruction to the physical server A 10 or transmits a pause instruction of the running VM to the physical server B 30. The VM management server 1 receives the instruction operation from the administrator or the like and transmits an execution instruction of live migration, which moves the VM2 running on the physical server A 10 to the physical server B 30, to the physical server A 10.

The NW management server 5 is an information processing apparatus that is connected to each of the physical switch A 20 and the physical switch B 40 through the network such as the Internet and manages information of a network device set to the network. For example, the NW management server 5 stores configuration information that is needed to connect the VM running on the physical server A 10 connected to the physical switch A 20 to another device. Likewise, the NW management server 5 stores configuration information that is needed to connect the VM running on the physical server B 30 connected to the physical switch B 40 to another device. When the NW management server 5 receives an acquisition request of configuration information from each physical switch, the NW management server 5 transmits the corresponding configuration information to the request source.

The physical server A 10 is an information processing apparatus that is connected to the VM management server 1 through the network, is connected to the physical switch A 20, and runs or pauses the VM. For example, the physical server A 10 monitors a state of the VM runs on the self device. When the state change of the VM is detected, the physical server A 10 transmits information including contents of the state change of the virtual machine to the physical switch A 20 to control communication between the self device or the VM and another device or another VM.

For example, the physical server A 10 detects that a new VM is generated or an existing VM is paused, according to a request from the VM management server 1. The physical server A 10 transmits information of the generated VM or the paused VM to the physical switch A 20. If the physical server A 10 detects that the live migration to move the VM2 to the physical server B 30 is executed, according to the request from the VM management server 1, the physical server A 10 transmits information indicating that the VM2 is being live migrated to the physical switch A 20.

The physical switch A 20 is a network device such as a switch that is connected to the physical server A 10 and is connected to the physical switch B 40 or the NW management server 5 through the network such as the Internet. The physical switch A 20 stores configuration information of the VM that runs on the physical server A 10 connected to the self device. The physical switch A 20 controls communication between the physical server A 10 or the VM on the physical server A 10 and another device or another VM, on the basis of the stored configuration information. When the physical switch A 20 receives VM information of the virtual machine from the physical server A 10, the physical switch A 20 updates the configuration information on the basis of the received information.

The physical server B 30 is an information processing apparatus that is connected to the VM management server 1 through the network, is connected to the physical switch B 40, and runs or pauses the VM. The physical server B 30 has the same configuration as that of the physical server A 10. Specifically, the physical server B 30 monitors a state of the VM that runs on the self device. When the state change of the VM is detected, the physical server B 30 transmits state change information indicating the changed state of the VM to the physical switch B 40 to control communication between the self device or the VM and another device or another VM.

The physical switch B 40 is a network device such as a switch that is connected to the physical server B 30 and is connected to the physical switch A 20 or the NW management server 5 through the network such as the Internet. The physical switch B 40 has the same configuration as that of the physical switch A 20. Specifically, the physical switch B 40 stores configuration information of the VM that runs on the physical server A 10 connected to the self device. The physical switch B 40 controls communication between the physical server B 30 or the VM on the physical server B 30 and another apparatus or another VM, on the basis of the stored configuration information. When the physical switch B 40 receives the state change information indicating that the state of the VM is changed from the physical server B 30, the physical switch B 40 updates the configuration information on the basis of the received state change information.

As such, if the physical server or the physical switch having the above configuration is used, communication of the virtual machine can be avoided from being disconnected after the migration is completed.

Configuration of Each Apparatus

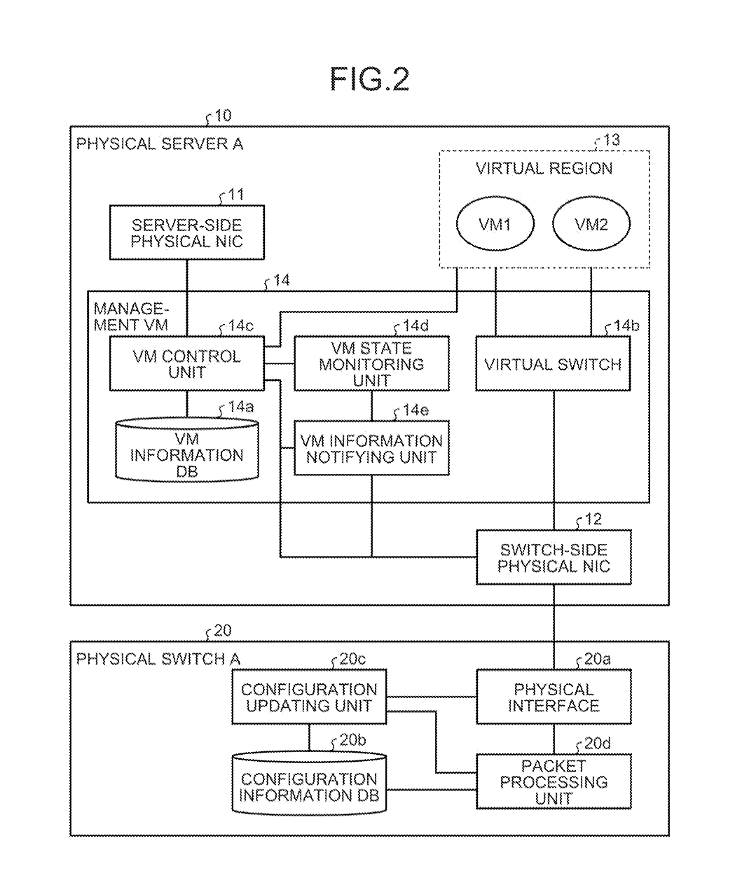

Next, the configuration of each of the VM management server 1, the NW management server 5, the physical server A 10, the physical switch A 20, the physical server B 30, and the physical switch B 40 illustrated in FIG. 1 will be described using FIG. 2. FIG. 2 is a block diagram illustrating the configuration of the physical server and the physical switch according to the first embodiment. Since the physical server A 10 and the physical server B 30 have the same configuration, only the physical server A 10 will be described herein. Further, since the physical switch A 20 and the physical switch B 40 have the same configuration, only the physical switch A 20 will be described herein.

Since the VM management server 1 has the same function as that of the general management server, the detailed description is not omitted. Specifically, the VM management server 1 has an input unit that receives an instruction from the administrator and a display unit that displays a variety of information, and stores information related to the VM that runs on the physical server A 10 or the physical server B 30. For example, the VM management server 1 stores information indicating that the VM1 and the VM2 are running on the physical server A 10 and the VM3 is running on the physical server B 30.

Since the NW management server 5 has the same function as that of the general management server, the detailed description is omitted. Specifically, the NW management server 5 has an input unit that receives an instruction from the administrator and a display unit that displays a variety of information, and stores the configuration information that is set to the physical switch A 20 or the physical switch B 40. For example, the NW management server 5 stores configuration information of the VM1, VM2, and VM3.

Configuration of the Physical Server

As illustrated in FIG. 2, the physical server A 10 has a server-side physical network interface card (NIC) 11, a switch-side physical NIC 12, a virtual region 13, and a management VM 14. Each control unit that is described herein is only exemplary and is not limitative thereto. For example, each control unit has an input unit such as a keyboard or a mouse, a display unit such as a display, and an electronic circuit such as a central processing unit (CPU).

The server-side physical NIC 11 is an interface that is connected to the VM management server 1. For example, the server-side physical NIC 11 receives a live migration instruction from the VM management server 1 and outputs the live migration instruction to the management VM 14. The server-side physical NIC 11 receives the live migration execution result from the management VM 14 and transmits the live migration execution result to the VM management server 1.

The switch-side physical NIC 12 is an interface that is connected to the physical switch A 20. For example, the switch-side physical NIC 12 transmits a VM information notification message, which indicates the information related to the VM becoming an object of the live migration output from the management VM 14, to the physical switch A 20. The switch-side physical NIC 12 receives a variety of information such as the configuration information of the VM from the physical switch A 20.

The virtual region 13 that is a region where the plural VMs generated by the management VM 14 are run and is a virtual region where VMs of an arbitrary number can be run. For example, in the virtual region 13, the VM1 and the VM2 are run, as illustrated in FIG. 2.

The management VM 14 has a VM information DB 14a, a virtual switch 14b, a VM control unit 14c, a VM state monitoring unit 14d, and a VM information notifying unit 14e. The management VM 14 is a control unit that executes various controls on the VM using the above components.

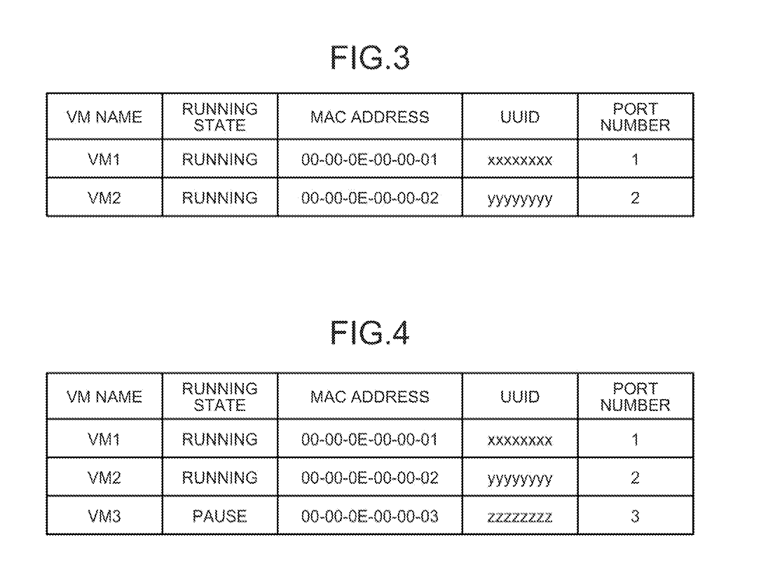

The VM information DB 14a stores information of the VMs that run on the virtual region 13 of the physical server A 10. For example, as illustrated in FIG. 3, the VM information DB 14a stores “VM1, Running, 00-00-0E-00-00-01, xxxxxxxx, and 1” as “a VM name, a running state, a media access control (MAC) address, a universally unique identifier (UUID), and a port number”. The VM information DB 14a stores “VM2, Running, 00-00-0E-00-00-02, yyyyyyyy, and 2” as “a VM name, a running state, a MAC address, a UUID, and a port number”. FIG. 3 illustrates an example of information that is stored in the VM information DB.

In this case, the stored “VM name” is information to identify the VM running on the physical server A 10. The “running state” is information indicating whether the VM runs. For example, when the VM is running, “Running” is stored, and when the VM is being paused or migrated, “Pause” is stored. The “MAC address” indicates a MAC address of the VM, the “UUID” is a unique identifier to identify the VM given by the management VM 14, and the “port number” is a port number of the virtual switch 14b to which the VM is connected. In this case, the variety of information to be stored is stored by the VM control unit 14c and the like to be described later.

The virtual switch 14b is a virtual network interface such as a bridge that has plural ports and connects the running VM and the switch-side physical NIC 12. For example, the virtual switch 14b connects the VM1 in the virtual region 13 to a port 1 and connects the VM2 in the virtual region 13 to a port 2. The virtual switch 14b controls communication between the VM1 or the VM2 and another physical server, another physical switch, another VM or the like.

The VM control unit 14c that is a control unit to realize a virtualization function controls to generate, pause, and move the VM. For example, when the VM control unit 14c receives a generation instruction of the VM from the VM management server 1 through the server-side physical NIC 11, the VM control unit 14c stores “the VM name, the running state, the MAC address, the UUID, and the port number” as information related to the instructed VM in the VM information DB 14a. When the VM control unit 14c receives a pause instruction of the VM from the VM management server 1 through the server-side physical NIC 11, the VM control unit 14c updates the “running state” corresponding to the instructed VM with “Pause”, in the VM information DB 14a.

When the VM control unit 14c receives an instruction to move the VM2 to the physical server B 30 from the VM management server 1 through the server-side physical NIC 11, the VM control unit 14c notifies the VM information notifying unit 14e that the live migration to move the VM2 starts. Next, the VM control unit 14c updates the “running state” corresponding to the instructed VM with “Pause”, in the VM information DB 14a. The VM control unit 14c starts live migration control of the VM2.

Since the live migration control executed by the VM control unit 14c is the same as the general migration control, the detailed description is omitted. For example, the VM control unit 14c executes precopy in a state where the VM2 as a movement object runs on the physical server A 10. Specifically, the VM control unit 14c transmits memory contents used by the VM control unit 14c to the physical server B 30 of the movement destination. The VM control unit 14c repeats the precopy according to the change amount of the memory.

Then, when the change amount of the memory becomes a predetermined value or less, the VM control unit 14c executes stop and copy. Specifically, the VM control unit 14c temporarily stops work for the VM2 as the movement object and transmits the memory contents used by the VM control unit 14c to the physical server B 30 of the movement destination. The VM control unit 14c runs the moved VM to restart the work, and transmits a gratuitous address resolution protocol (GARP) packet to the physical switch B 40. In this way, the control of the live migration where the VM2 is moved from the physical server A 10 to the physical server B 30 is completed.

The VM state monitoring unit 14d monitors a state of the virtual machine that runs on the self device. That is, the VM state monitoring unit 14d monitors the number of virtual machines running on the physical server A 10 or the state change of the virtual machines and outputs the monitor result to the VM information notifying unit 14e. For example, the VM state monitoring unit 14d always monitors the VM information DB 14a, detects addition or deletion of the record, and outputs the detected information to the VM information notifying unit 14e.

For example, as illustrated in FIG. 4, the VM control unit 14c newly adds “VM3, Pause, 00-00-0E-00-00-03, zzzzzzzz, and 3” to the VM information DB 14a. In this case, the VM state monitoring unit 14d detects a state where the live migration control is executed and the VM3 is moved from another physical server, that is, detects the live migration control of the VM3, and outputs this information to the VM information notifying unit 14e. When the record is deleted from the VM information DB 14a, the VM state monitoring unit 14d detects that the VM is paused or moved by the VM control unit 14c and outputs the detection result to the VM information notifying unit 14e. FIG. 4 illustrates an example of the case where the record is added to the VM information DB.

When the state change of the VM is detected by the VM state monitoring unit 14d, the VM information notifying unit 14e transmits state change information indicating the changed state of the VM to the physical switch A 20 to control communication between the self device or the VM on the self device and another device or another VM. For example, if the VM information notifying unit 14e receives information indicating that the record of the VM2 is deleted from the VM information DB 14a from the VM state monitoring unit 14d, the VM information notifying unit 14e transmits information indicating that the VM2 is paused to the physical switch A 20. If the VM information notifying unit 14e receives information indicating that the record of the VM3 is newly added to the VM information DB 14a from the VM state monitoring unit 14d, the VM information notifying unit 14e transmits information indicating that the VM3 newly runs to the physical switch A 20.

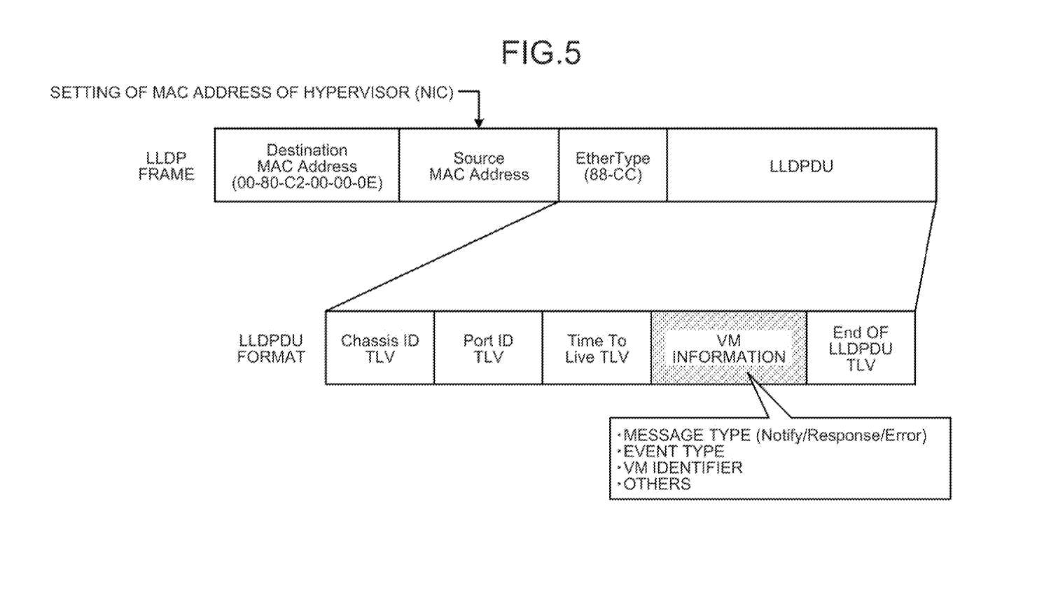

For example, the VM information notifying unit 14e transmits information including contents of the state change of the virtual machine to the physical switch A 20, through a VM information notification message using a link layer discovery protocol (LLDP) frame illustrated in FIG. 5. An LLDP frame illustrated in FIG. 5 has “Destination MAC Address, Source MAC Address, EtherType, and LLDPDU”. The “Destination MAC Address” is a MAC address of the physical switch B 40 corresponding to the transmission destination and the “Source MAC Address” is a MAC address of the physical server A 10 corresponding to the transmission source. The “EtherType” is information indicating a type of a communication protocol. For example, in the case of the LLDP, the “EtherType” is 88-CC. The “LLDPDU” is a data unit of the LLDP where data to be transmitted is stored.

As illustrated in FIG. 5, the “LLDPDU” has “Chassis ID TLV, Port ID TLV, Time To Live TLV, VM information TLV, and End Of LLPDU TLV”, and all regions are configured using three fields of “TLV=Type, Length, and Value”. The “Chassis ID TLV” that is device identification information is such as a MAC address, an Internet protocol (IP) address or an identifier to identify the physical switch A 20. The “Port ID TLV” that is information indicating a port identifier is an interface or a port number of the physical switch A 20. The “Time To Live TLV” is a valid period of information that is stored in the corresponding frame.

The “VM information TLV” is a region where VM information to be notified to the physical switch A 20 is stored. For example, in the “VM information TLV”, a message type, an event type, and a VM identifier are stored. As the message type that is information indicating a type of the VM information notification message, Notify indicating a common notification, Response indicating a response, and Error indicating an error are stored. As the event type that is information indicating the state change of the VM notified by the VM information notification message, new running, pause, and movement are stored. As the VM identifier that is information to specify the VM becoming a notification object based on the VM information notification message, a MAC address or a UUID of a newly running or paused VM or a moving VM is stored. The “End Of LLPDU TLV” is information that indicates a terminal of the LLDPDU.

In this case, an example of the case where the MAC address of the physical server A 10 is stored in the “Source MAC Address” is described. However, a MAC address of a hypervisor such as a unique MAC address other than that of the VM may be set. For example, the physical switch that receives a packet where the MAC address of the VM is set to the “Source MAC Address” may learn an address of the packet. In this case, in spite of the migration being executed, forwarding database (FDB) information of the switch may be changed and disconnection of communication of the VM during the live migration may be generated. Therefore, the MAC address of the hypervisor is set to the “Source MAC Address” to avoid the disconnection of the communication.

In this case, the LLDP is used as the VM information notification message. However, a protocol or a frame structure other than the LLDP may be used. The MAC address of the VM is notified as the VM identifier. However, another identifier such as the UUID that can identify the VM may be notified. FIG. 5 illustrates an example of the VM information notification message.

Configuration of the Physical Switch

As illustrated in FIG. 2, the physical switch A 20 has a physical interface 20a, a configuration information DB 20b, a configuration updating unit 20c, and a packet processing unit 20d. Each control unit that is described herein is only exemplary and is not limitative thereto. For example, each control unit has a storage unit that stores path information indicating a path of data such as a received packet or frame and a control unit that controls switching on the basis of the path information.

The physical interface 20a is an interface that is connected to the physical server A 10, the physical server B 30, the physical switch B 40, and the NW management server 5, and receives a variety of information from the connected devices and transmits a variety of information to the connected devices. For example, the physical interface 20a receives an information notification message from the physical server A 10 and transmits an information notification response message that is a response to the received information notification message.

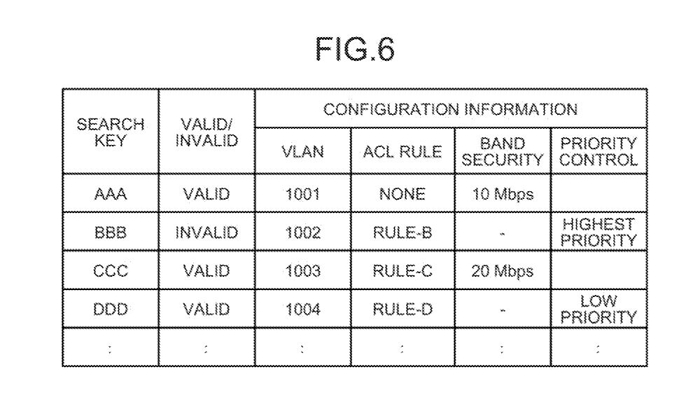

The configuration information DB 20b stores configuration information of the VM that runs on the physical server A 10 connected to the self device. For example, as illustrated in FIG. 6, the configuration information DB 20b stores “AAA, valid, and (1001, None, 10 Mbps, -) as “search KEY, valid/invalid, configuration information (VLAN, ACL rule, band security, and priority control”. The configuration information DB 20b stores “BBB, invalid, and (1002, Rule-B, -, and highest priority). FIG. 6 illustrates an example of information that is stored in the configuration information DB.

In this case, the stored “search KEY” is a key that is used to search a record stored in the configuration information DB 20b. For example, the “search KEY” is information such as the MAC address or the UUID of the VM that is used to uniquely-identify the VM. The “valid/invalid” is information that indicates whether the record is valid or invalid. The “VLAN” is a VLAN identifier that is used to identify a VLAN which the VM belongs to, and the “ACL rule” is information that is used to specify a rule of access control applied to the VM. The “band security” is a band that is allocated to the VM. In this case, the stored band is secured. The “priority control” is information that indicates whether various processes such as communication control are preferentially executed. When the priority is highest, “highest priority” is stored. When the priority is low, “low priority” is stored. When there is no information to be stored, the priority control is not executed. In this case, the configuration information is only exemplary and is not limitative thereto. Another configuration information may be arbitrarily added or deleted.

For example, the “AAA, valid, and (1001, None, 10 Mbps, and -) indicate that VLAN (1001) and band control (10 Mbps) are set to the VM of the MAC address “AAA” and the corresponding setting is valid. The “BBB, invalid, and (1002, Rule-B, -, and highest priority) indicate that VLAN (1002), access control (Rule-B), and priority control (highest priority) are set to the VM of the MAC address “BBB” and the corresponding setting is invalid. The rule of the access control is associated with an identifier to identify the rule and the association result is stored in a predetermined storage unit.

Referring back to FIG. 2, when the configuration updating unit 20c receives information of the VM from the physical switch A 20, the configuration updating unit 20c updates the configuration information that is stored in the configuration information DB 20b, on the basis of the received information. For example, when the configuration updating unit 20c receives a VM information notification message indicating that the VM2 is paused from the physical switch A 20, the configuration updating unit 20c acquires a MAC address of the VM2 from the VM information TLV of the VM information notification message. Subsequently, the configuration updating unit 20c uses the MAC address of the VM2 as a search key and searches a record corresponding to the VM2 from the configuration information DB 20b. The configuration updating unit 20c changes “valid/invalid” of the searched record to “invalid”, and invalidates the configuration of the VM2. The configuration updating unit 20c may delete the searched record from the configuration information DB 20b and invalidate the configuration of the VM2.

When the configuration updating unit 20c receives the VM information notification message indicating that the VM3 is being moved or newly run from the physical switch A 20, the configuration updating unit 20c acquires the MAC address of the VM3 from the VM information TLV of the VM information notification message. The configuration updating unit 20c transmits information, such as the MAC address, which specifies the VM3, to the NW management server 5, and acquires the configuration information of the VM3 from the NW management server 5. Subsequently, the configuration updating unit 20c uses the MAC address of the VM3 as the “search KEY”, changes the “valid/invalid” to the “valid”, associates the corresponding information and the configuration information with each other, and stores the association result in the configuration information DB 20b. After a predetermined time passes from storage of the configuration in the configuration information DB 20b, the configuration updating unit 20c may automatically change the “valid/invalid” from the “invalid” to the “valid”.

The packet processing unit 20d controls communication between the physical server A 10 or the VM and another apparatus or another VM, on the basis of the configuration information stored in the configuration information DB 20b. For example, the packet processing unit 20d reads out a rule corresponding to the ACL rule stored in the configuration information DB 20b, from the predetermined storage unit, and executes access control. The packet processing unit 20d executes QoS control to secure the band stored in the configuration information DB 20b.

Specific Example (Migration of the VM2)

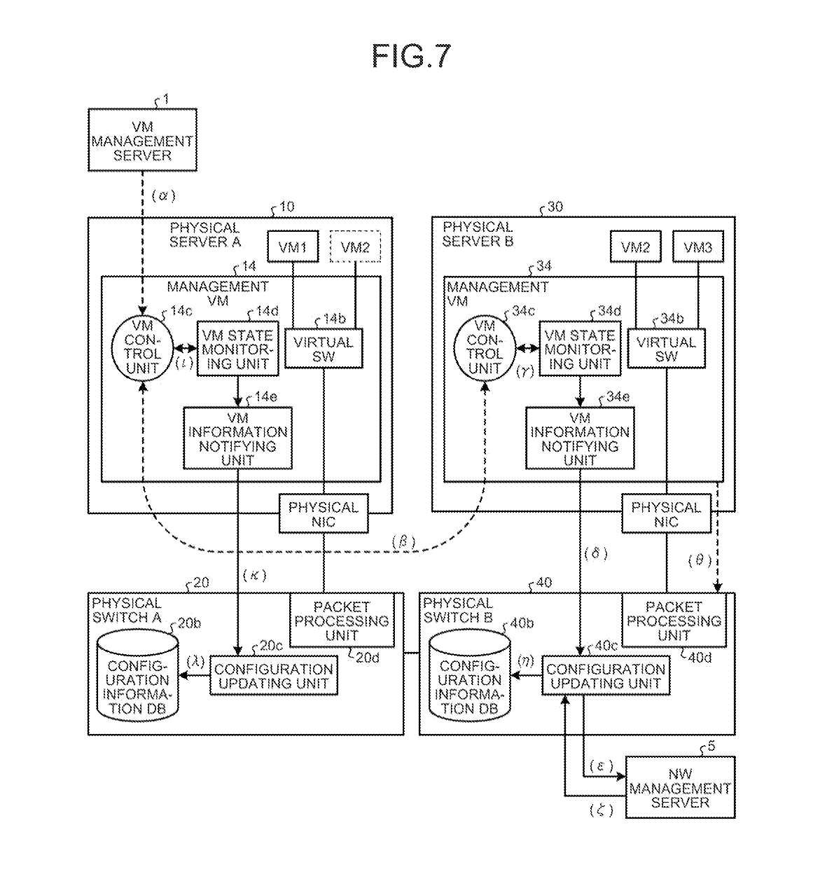

Next, an example of the case where the VM2 running on the physical server A 10 is live migrated to the physical server B 30 will be described using FIG. 7. FIG. 7 illustrates an example of the case where the VM2 of the physical server A is live migrated to the physical server B.

Since the entire configuration illustrated in FIG. 7 is the same as that illustrated in FIG. 1, the description is not repeated. As illustrated in FIG. 7, the VM control unit 14c of the physical server A 10 receives a live migration instruction of the VM2 from the VM management server 1 (refer to (α) of FIG. 7). The VM control unit 14c of the physical server A 10 starts live migration control of the VM2 between a VM control unit 34c of the physical server B 30 and the VM control unit 14c (refer to (β) of FIG. 7). At this time, the VM control unit 34c of the physical server B 30 generates a record of the VM2 in a VM information DB 34a that is not illustrated in FIG. 7.

A VM state monitoring unit 34d of the physical server B 30 detects that the record of the VM2 is added to the VM information DB 34a, and notifies a VM information notifying unit 34e that the VM2 is added (refer to (γ) of FIG. 7). Next, the VM information notifying unit 34e of the physical server B 30 that receives the notification of the addition of the VM2 from the VM state monitoring unit 34d generates a VM information notification message of an event type “movement” including such as the MAC address of the added VM2 and transmits the VM information notification message to the physical switch B 40 (refer to (δ) of FIG. 7). The MAC address of the VM2 can be acquired from the live migration control, for example.

A configuration updating unit 40c of the physical switch B 40 acquires the MAC address of the VM2 from the VM information notification message indicating that the VM2 is being moved or newly run, and transmits the MAC address to the NW management server 5 (refer to (ε) of FIG. 7). Next, the configuration updating unit 40c of the physical switch B 40 acquires the configuration information of the VM2 from the NW management server 5 (refer to (ξ) of FIG. 7). Next, the configuration updating unit 40c uses the MAC address of the VM2 as the “search KEY”, changes the “valid/invalid” to the “valid”, associates the corresponding information and the configuration information with each other, and stores the association result in a configuration information DB 40b (refer to (η) of FIG. 7). Then, if the live migration is completed, a packet processing unit 40d of the physical switch B 40 receives the GARP packet from the physical server B 30 and recognizes that the live migration is completed (refer to (θ) of FIG. 7).

Meanwhile, in the physical server A 10, the VM state monitoring unit 14d detects that the record of the VM2 is deleted from the VM information DB 14a not illustrated in FIG. 7 and notifies the VM information notifying unit 14e that the VM2 is paused (refer to (τ) of FIG. 7). Next, the VM information notifying unit 14e generates a VM information notification message of an event type “pause” including such as the MAC address of the deleted VM2 and transmits the VM information notification message to the physical switch A 20 (refer to (κ) of FIG. 7). Next, the configuration updating unit 20c of the physical switch A 20 deletes the record corresponding to the MAC address of the VM2 included in the VM information notification message of the event type “pause” from the configuration information DB 20b (refer to (λ) of FIG. 7). In this way, communication disconnection can be prevented from being generated, while the live migration can be completed.

Flow of a Process

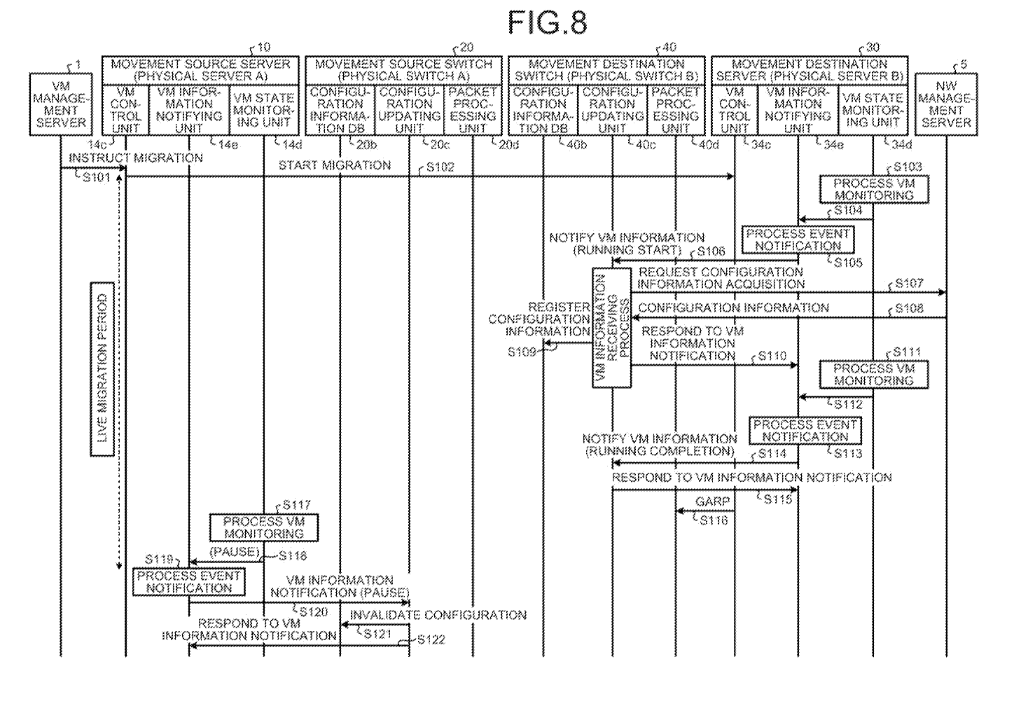

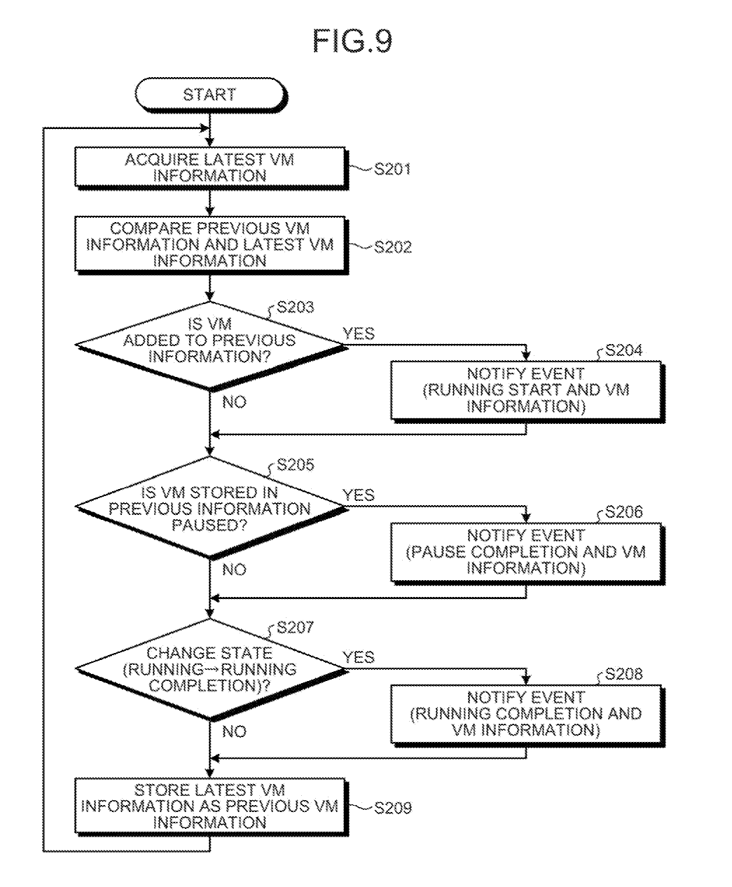

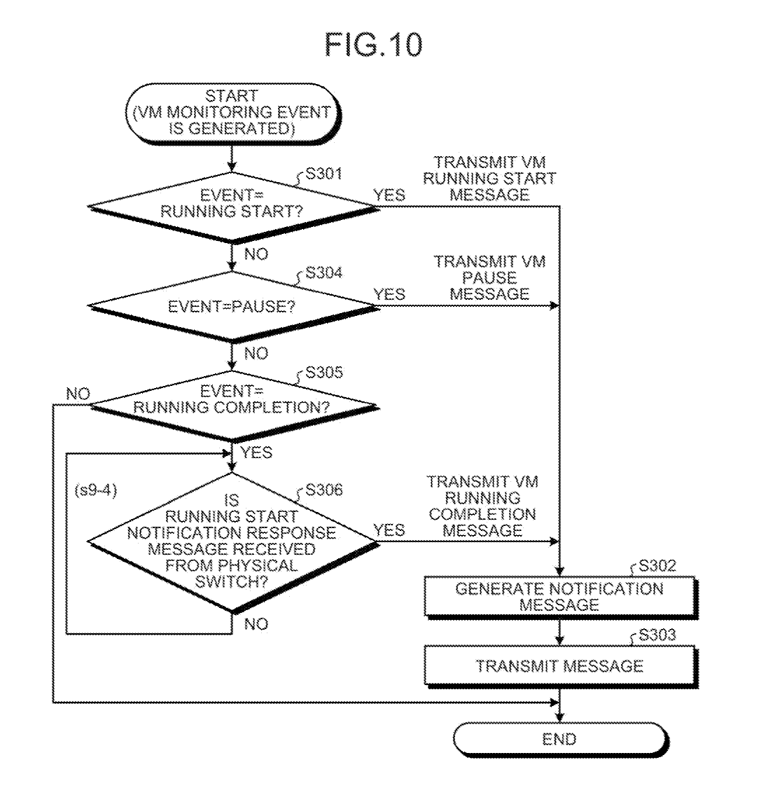

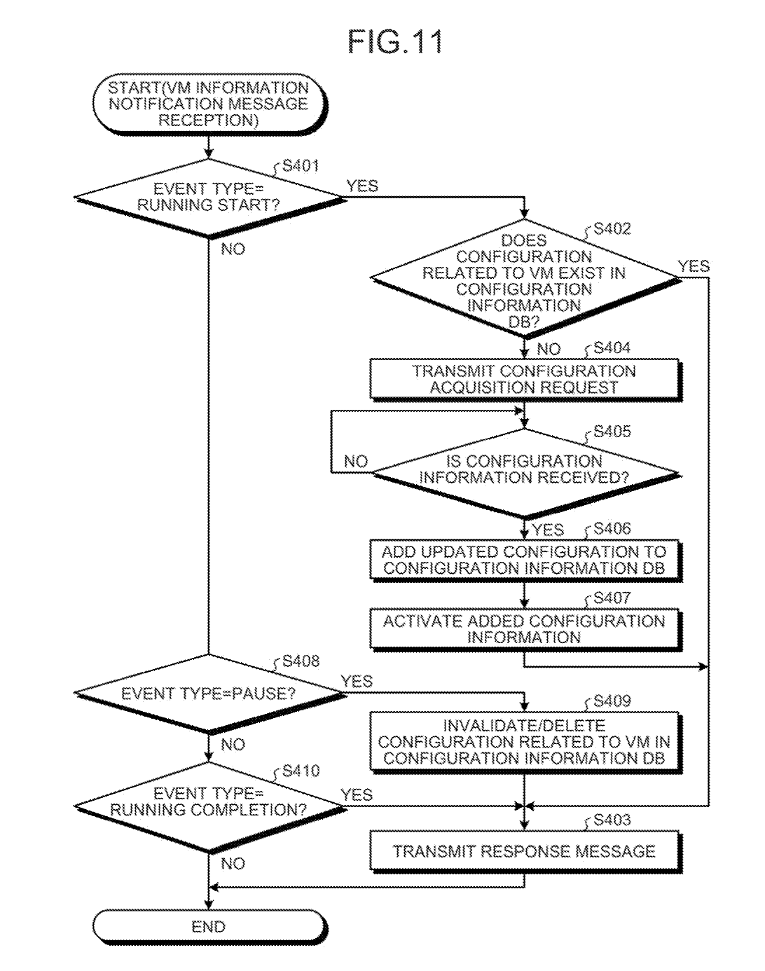

Next, a flow of the processes of the system according to the first embodiment will be described using FIGS. 8 to 11. FIG. 8 illustrates an operation sequence of the system according to the first embodiment, FIG. 9 is a flowchart illustrating a flow of a VM monitoring process, FIG. 10 is a flowchart illustrating a flow of an event notifying process, and FIG. 11 is a flowchart illustrating a flow of a VM information receiving process.

In this case, an example of the case where the VM running on the physical server A 10 is moved to the physical server B 30 will be described. That is, the case where the physical server A 10 is a movement source server, the physical switch A 20 is a movement source switch, the physical server B 30 is a movement destination server, and the physical switch B 40 is a movement destination switch will be described.

Sequence

As illustrated in FIG. 8, the VM management server 1 transmits a start instruction of the live migration control to the physical server A 10 (step S101). The VM control unit 14c of the physical server A 10 starts the live migration control of the VM between the VM control unit 34c of the physical server B 30 and the VM control unit 14c (step S102). At this time, the VM control unit 34c of the physical server B 30 generates a record of the VM as a movement object in the VM information DB 34a.

Next, the VM state monitoring unit 34d of the physical server B 30 executes the VM monitoring process and detects that the live migration of the VM has started (step S103). The VM state monitoring unit 34d notifies the VM information notifying unit 34e that the VM is added to the VM information DB 34a (step S104).

Next, the VM information notifying unit 34e of the physical server B 30 executes the event notifying process and generates a VM information notification message to notify the start of running of the VM (step S105). The VM information notifying unit 34e transmits the generated VM information notification message to the physical switch B 40 (step S106).

The configuration updating unit 40c of the physical switch B 40 executes a VM information receiving process. Specifically, the configuration updating unit 40c acquires a MAC address of the VM that is included in the received VM information notification message to notify the start of running of the VM, and transmits a configuration information acquisition request corresponding to the MAC address to the NW management server 5 (step S107). The NW management server 5 that receives the request transmits configuration information of the VM corresponding to the MAC address included in the request to the physical switch B 40 as a response (step S108). Next, the configuration updating unit 40c uses the MAC address of the VM as a search key, stores the received configuration information in the configuration information DB 40b, and activates the configuration information, that is, changes a state as “valid” (step S109). Next, the configuration updating unit 40c transmits a response, which indicates that the registration and activation of the configuration information end, to the physical server B 30 (step S110).

Next, the VM state monitoring unit 34d of the physical server B 30 executes the VM monitoring process and detects that the live migration of the VM is completed (step S111). The VM state monitoring unit 34d notifies the VM information notifying unit 34e that the live migration is completed (step S112).

Next, the VM information notifying unit 34e of the physical server B 30 executes the event notifying process and generates a VM information notification message to notify the completion of running of the VM (step S113). The VM information notifying unit 34e transmits the generated VM information notification message to the physical switch B 40 (step S114).

Next, the configuration updating unit 40c of the physical switch B 40 transmits a response to the received VM information notification message to the physical server B 30 (step S115). As a result, a management VM 34 of the physical server B 30 transmits the GARP to the physical switch B 40 (step S116).

As described above, the process is executed by the movement destination side, and the VM state monitoring unit 14d of the physical server A 10 of the movement source executes the VM monitoring process and detects that the live migration of the VM starts and the VM is paused (step S117). The VM state monitoring unit 14d notifies the VM information notifying unit 14e that the VM stored in the VM information DB 34a is paused (step S118).

Next, the VM information notifying unit 14e of the physical server A 10 executes the event notification process and generates a VM information notification message to notify the pause of the VM (step S119). The VM information notifying unit 14e transmits the generated VM information notification message to the physical switch A (step S120).

The configuration updating unit 20c of the physical switch A 20 refers to the configuration information DB 20b and invalidates configuration information where the MAC address of the VM included in the received message is used as a search key (step S121). Next, the configuration updating unit 20c transmits a response indicating that the invalidation of the configuration information ends to the physical server A 10 (step S122).

Flow of the VM Monitoring Process

Next, the flow of the VM monitoring process that is illustrated in steps S103, S111, and S117 of FIG. 8 will be described. In this case, an example of the case where the physical server B 30 executes the VM monitoring process will be described.

As illustrated in FIG. 9, the VM state monitoring unit 34d of the physical server B 30 refers to the VM information DB 34a to acquire latest VM information (step S201), and compares the acquired VM information with the previous VM information stored in the memory (step S202).

When the VM is added to the previous VM information (step S203: Yes), the VM state monitoring unit 34d notifies the VM information notifying unit 34e of event information indicating “an event type=running start and a VM identifier=a MAC address of the added VM” (step S204).

Meanwhile, when the VM is not added to the previous VM information (step S203: No), the VM state monitoring unit 34d determines whether the VM is deleted (paused) from the previous VM information (step S205). When the VM is deleted from the previous VM information (step S205: Yes), the VM state monitoring unit 34d notifies the VM information notifying unit 34e of event information indicating “an event type=pause completion and a VM identifier=a MAC address of the paused VM” (step S206).

Meanwhile, when the VM is not deleted from the previous VM information (step S205: No), the VM state monitoring unit 34d determines whether a state of the VM is changed from the previous VM information (step S207). For example, the VM state monitoring unit 34d determines whether there is a VM whose state is changed from “Pause” to “Running” in the previous VM information. When there is the VM whose state is changed from the previous VM information (step S207: Yes), the VM state monitoring unit 34d notifies the VM information notifying unit 34e of event information indicating “an event type=running completion and a VM identifier=a MAC address of the changed VM” (step S208).

The VM state monitoring unit 34d stores latest VM information as the previous VM information in a predetermined storage unit such as the memory (step S209), returns to step S201, and repeats the following processes.

Flow of the Event Notifying Process

Next, the flow of the event notifying process that is illustrated in steps S105, S113, and S119 of FIG. 8 will be described. In this case, an example of the case where the physical server B 30 executes the event notifying process will be described.

As illustrated in FIG. 10, the VM information notifying unit 34e that receives the event notification from the VM state monitoring unit 34d determines whether the received event notification is the running start (step S301). When the received event notification is the running start (step S301: Yes), the VM information notifying unit 34e generates a VM information notification message of “an event type=running start and a VM identifier=a MAC address of the added VM” (step S302). Next, the VM information notifying unit 34e transmits the generated VM information notification message to the physical switch B (step S303).

Meanwhile, when the received event notification is not the running start (step S301: No), the VM information notifying unit 34e determines whether the received event notification is the pause (step S304). When the received event notification is the pause (step S304: Yes), the VM information notifying unit 34e generates a VM information notification message of “an event type=pause completion and a VM identifier=a MAC address of the paused VM” (step S302). Next, the VM information notifying unit 34e transmits the generated VM information notification message to the physical switch B 40 (step S303).

Meanwhile, when the received event notification is not the pause (step S304: No), the VM information notifying unit 34e determines whether the received event notification is the running completion (step S305). When the received event notification is not the running completion (step S305: No), the VM information notifying unit 34e ends the process without generating a VM information notification message.

Meanwhile, when the received event notification is the running completion (step S305: Yes), the VM information notifying unit 34e determines whether a response message to the running start notification is received from the physical switch B 40 (step S306). When the response message is received (step S306: Yes), the VM information notifying unit 34e generates a VM information notification message of “an event type=running completion and a VM identifier=a MAC address of the running completed VM” (step S302). Next, the VM information notifying unit 34e transmits the generated VM information notification message to the physical switch B 40 (step S303).

Flow of the VM Information Receiving Process

Next, a flow of the VM information receiving process illustrated in FIG. 8 will be described. In this case, an example of the case where the physical switch B 40 executes the VM information receiving process will be described.

As illustrated in FIG. 11, the configuration updating unit 40c of the physical switch B 40 that receives the information notification message from the physical server B 30 determines whether an event type of the received message is the running start (step S401).

When the event type is the running start (step S401: Yes), the configuration updating unit 40c determines whether configuration information corresponding to the VM exists in the configuration information DB 40b (step S402). For example, the configuration updating unit 40c determines whether configuration information corresponding to a VM identifier of the received message is stored.

When the configuration information corresponding to the VM exists in the configuration information DB 40b (step S402: Yes), the configuration updating unit 40c transmits a response message to the physical server B 30 (step S403).

Meanwhile, when the configuration information corresponding to the VM does not exist in the configuration information DB 40b (step S402: No), the configuration updating unit 40c transmits a configuration information acquisition request of the VM to the NW management server 5 (step S404).

When the configuration information of the VM is received (step S405: Yes), the configuration updating unit 40c uses a MAC address of the VM as a search key and stores the received configuration information in the configuration information DB 40b (step S406). Next, the configuration updating unit 40c activates newly stored configuration information (step S407) and transmits a response message indicating that the configuration information is completely stored to the physical server B 30 (step S403).

In step S401, when the event type is not the running start (step S401: No), the configuration updating unit 40c determines whether the event type is the pause (step S408).

When the event type is the pause (step S408: Yes), the configuration updating unit 40c refers to the configuration information DB 40b and invalidates or deletes the configuration information corresponding to the VM (step S409). Next, the configuration updating unit 40c transmits a response message indicating that the invalidation of the configuration information is completed to the physical server B 30 (step S403).

Meanwhile, when the event type is not the pause (step S408: No), the configuration updating unit 40c determines whether the event type is the running completion (step S410). When the event type is the running completion (step S410: Yes), the configuration updating unit 40c transmits a response message to the physical server B 30 (step S403). When the event type is not the running completion (step S410: No), the configuration updating unit 40c ends the process.

### Effect According to First Embodiment

As such, according to the first embodiment, network setting of the physical switch B 40 that is connected to the physical server B 30 of the movement destination is executed immediately after the live migration process starts between the physical server A 10 and the physical server B 30. As a result, the network setting can be completed until the live migration process is completed, and the VM that is moved immediately after the live migration is completed can be made to enter in a communication enabled state.

If the live migration control between the physical servers is completed, the VM state monitoring unit 34d of the physical server B 30 of the movement destination detects that the VM as the movement object completely enters in a running state. At this time, if a response message of the previously transmitted running start notification event message is received from the physical switch B 40, the running completion event and the VM identifier are notified to the VM state monitoring unit 34d. The VM state monitoring unit 34d notifies the physical switch B 40 of the VM information notification message including the running completion event.

In the first embodiment, when the physical switch B 40 receives the running completion message, the process is not executed. Meanwhile, the reception of the running completion message can be confirmed in the side of the physical switch B 40. For example, after transmitting the response message of the running start event, the physical switch B 40 monitors whether a VM information notification message including the running completion event can be received from the physical server B 30 in a constant time. When the VM information notification message cannot be received in the constant time, the physical switch B 40 may determine that the VM cannot be run due to some circumstances and invalidate the configuration information of the VM.

Meanwhile, when the live migration process between the physical servers is completed, the VM state monitoring unit 14d of the physical server A 10 of the movement source detects the VM pause event. At this time, the VM state monitoring unit 14d of the physical server A 10 transmits a VM information notification message including a VM pause event and a VM identifier to the physical switch A 20. The configuration updating unit 20c of the physical switch A 20 that receives the message invalidates or deletes the configuration information attached to the VM identifier in the configuration information DB 20b. Thereby, the configuration information that becomes unnecessary in the physical switch side of the movement source due to the live migration can be deleted.

### [b ] Second Embodiment

Meanwhile, the present invention can be applied to the case where a VM is newly run or paused, in addition to the live migration described in the first embodiment. In a second embodiment, an operation sequence of when the VM is newly run and an operation sequence of when the VM is paused will be described.

New Running

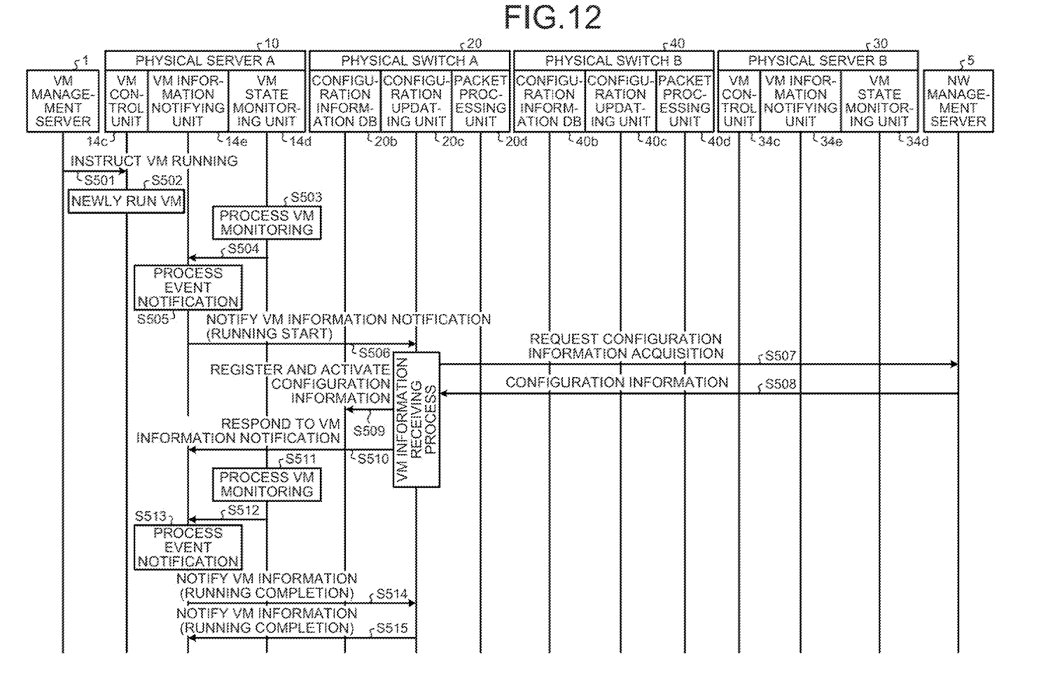

First, the operation sequence of when the VM is newly run will be described using FIG. 12. FIG. 12 illustrates an operation sequence of when a VM is newly run in a system according to the second embodiment.

As illustrated in FIG. 12, the VM control unit 14c of the physical server A 10 that receives a new running instruction of the VM from the VM management server 1 runs the designated VM (steps S501 and S502). For example, the VM control unit 14c generates a record where a MAC address of the VM is used as a search key in the VM information DB 14a or connects the VM to the virtual switch 14b.

The VM state monitoring unit 14d of the physical server A 10 executes the VM monitoring process and detects that the new VM is stored in the VM information DB 14a (step S503). The VM state monitoring unit 14d notifies the VM information notifying unit 14e that the VM is added to the VM information DB 14a (step S504).

Next, the VM information notifying unit 14e of the physical server A 10 executes the event notifying process and generates a VM information notification message to notify the new running start of the VM (step S505). The VM information notifying unit 14e transmits the generated VM information notification message to the physical switch A 20 (step S506).

The configuration updating unit 20c of the physical switch A 20 executes a VM information receiving process. Specifically, the configuration updating unit 20c acquires a MAC address of the VM that is included in the received VM information notification message to notify the running start of the VM, and transmits a configuration information acquisition request corresponding to the MAC address to the NW management server 5 (step S507). The NW management server 5 that receives the request transmits configuration information of the VM corresponding to the MAC address included in the request to the physical switch A 20 as a response (step S508). Next, the configuration updating unit 20c uses the MAC address of the VM as a search key, stores the received configuration information in the configuration information DB 20b, and activates the configuration information, that is, changes a state as “valid” (step S509). Next, the configuration updating unit 20c transmits a response, which indicates that the registration and activation of the configuration information end, to the physical server A 10 (step S510).

Next, the VM state monitoring unit 14d of the physical server A 10 executes the VM monitoring process and detects that the new running of the VM is completed (step S511). The VM state monitoring unit 14d notifies the VM information notifying unit 14e that the running is completed (step S512).

Next, the VM information notifying unit 14e of the physical server A 10 executes the event notifying process and generates a VM information notification message to notify the running completion of the VM (step S513). The VM information notifying unit 14e transmits the generated VM information notification message to the physical switch A 20 (step S514).

Next, the configuration updating unit 20c of the physical switch A 20 transmits a response to the received VM information notification message to the physical server A 10 (step S515). As a result, the new running of the VM in the physical server A 10 is completed.

At the Time of a Pause

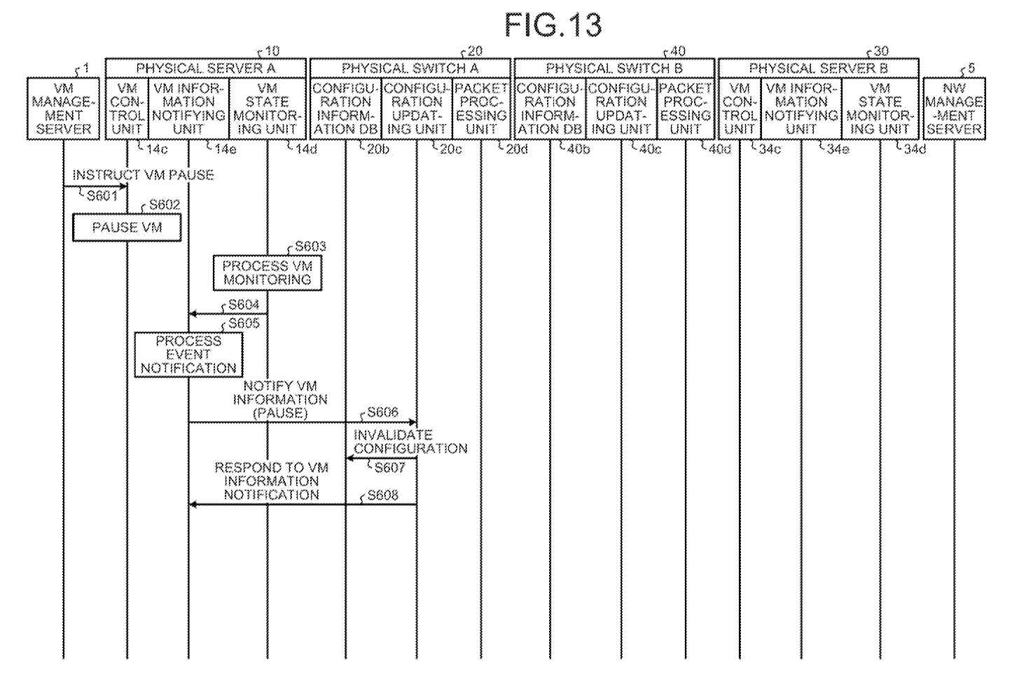

Next, the operation sequence of when the VM is paused will be described using FIG. 13. FIG. 13 illustrates an operation sequence of when the VM is paused in the system according to the second embodiment.

As illustrated in FIG. 13, the VM control unit 14c of the physical server A 10 that receives a pause instruction of the VM from the VM management server 1 pauses the designated VM (steps S601 and S602). For example, the VM control unit 14c deletes a record where a MAC address of the VM is used as a search key from the VM information DB 14a.

The VM state monitoring unit 14d of the physical server A 10 executes the VM monitoring process and detects that the VM is deleted from the VM information DB 14a (step S603). The VM state monitoring unit 14d notifies the VM information notifying unit 14e that the VM is deleted from the VM information DB 14a (step S604).

Next, the VM information notifying unit 14e of the physical server A 10 executes the event notifying process and generates a VM information notification message to notify the pause of the VM (step S605). The VM information notifying unit 14e transmits the generated VM information notification message to the physical switch A (step S606).

The configuration updating unit 20c of the physical switch A 20 refers to the configuration information DB 20b and invalidates configuration information where the MAC address of the VM included in the received message is used as a search key (step S607). Next, the configuration updating unit 20c transmits a response indicating that the invalidation of the configuration information is completed to the physical server A 10 (step S608). As a result, pause of the VM in the physical server A 10 is completed.

According to the second embodiment, in the case where the virtual machine is run or paused as well as the case of the live migration process, setting of the physical switch can be changed using the same structure.

### [c] Third Embodiment

In the first embodiment, the example of the case where the configuration information of the physical switch is stored for each virtual machine is described. However, in a third embodiment, an operation example of the case where plural virtual machines shares one configuration information will be described. In the case where one system is configured using the plural virtual machines or the case where the plural virtual machines are operated in the same section, one configuration information may be used for a virtual machine group.

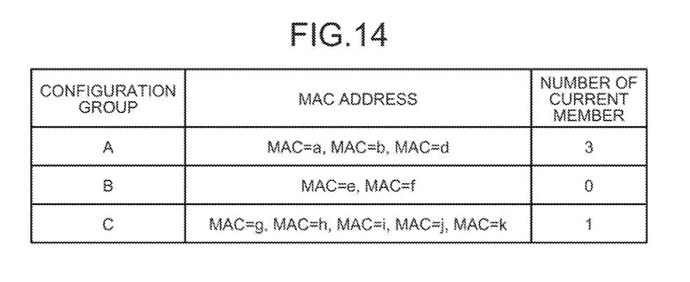

In order to correspond to the above cases, a group management DB illustrated in FIG. 14 is provided in the physical switch and a correspondence relationship of a VM identifier (MAC address) and a group identifier and the number of currently running members (VM number) are managed. The configuration management DB of FIG. 6 that is described in the first embodiment is also provided in each physical switch. However, a search key is not the MAC address of the virtual machine, but becomes a group identifier. FIG. 14 illustrates an example of a group management DB where configuration information is grouped and stored by the physical switch according to the third embodiment.

The group management DB illustrated in FIG. 14 stores “A, MAC=a·MAC=b·MAC=d, 3” or “B, MAC=e·MAC=f, 0” as “a configuration group, a MAC address, and a current number of members”. Further, the group management DB stores “C, MAC=g·MAC=h·MAC=i·MAC=j·MAC=k, 1” and the like.

In this case, the stored “configuration group” is an identifier to identify the shared configuration group and becomes a search key of a configuration management DB. The “MAC address” is a MAC address of the VM that belongs to the configuration group, and the “current number of members” is the number of currently running VMs.

For example, the “A, MAC=a·MAC=b·MAC=d, 3” indicates that all of the VM having a MAC address of a, the VM having a MAC address of b, and the VM having a MAC address of d belong to a group A and are running. The “B, MAC=e·MAC=f, 0” indicates that both the VM having a MAC address of e and the VM having a MAC address of f belong to a group B and are being paused. The “C, MAC=g·MAC=h·MAC=i·MAC=j·MAC=k, 1” indicates that the VM having a MAC address of g and the VM having a MAC address of h belong to a group C, the VM having a MAC address of i, the VM having a MAC address of j, and the VM having a MAC address of k belong to the group C, and one of all the VMs is running.

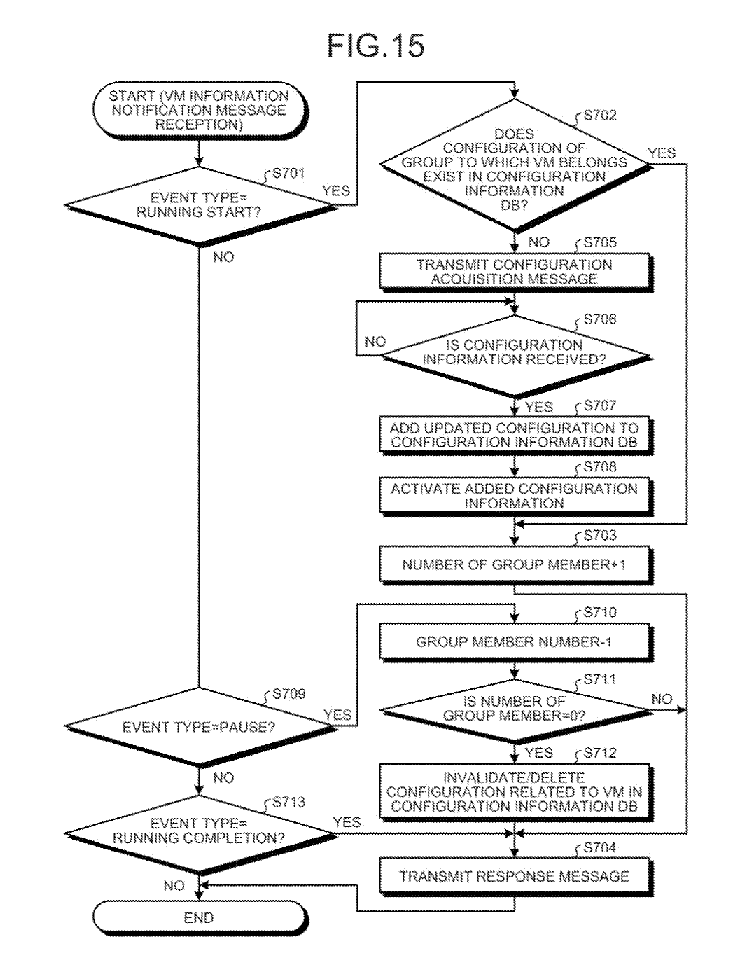

Next, a VM information receiving process in the physical switch that has the group management DB illustrated in FIG. 14 will be described using FIG. 15. FIG. 15 is a flowchart illustrating a flow of the VM information receiving process that is executed by the physical switch according to the third embodiment. In this case, an example of the case where the physical switch B 40 executes the VM information receiving process will be described.

As illustrated in FIG. 15, the configuration updating unit 40c of the physical switch B 40 that receives the information notification message from the physical server B 30 determines whether the event type of the received message is the running start (step S701).

When the event type is the running start (step S701: Yes), the configuration updating unit 40c determines whether configuration information corresponding to the group to which the VM belongs exists in the configuration information DB 40b (step S702). For example, the configuration updating unit 40c specifies a configuration group corresponding to a VM identifier (MAC address) of the received message from the group management DB (refer to FIG. 14). The configuration updating unit 40c determines whether configuration information where the specified configuration group is used as a search key exists in the configuration information DB 40b.

When the configuration information corresponding to the group to which the VM belongs exists in the configuration information DB 40b (step S702: Yes), the configuration updating unit 40c increments the number of members in the group management DB (step S703). Next, the configuration updating unit 40c transmits a response message indicating that the configuration information is registered to the physical server B 30 (step S704).

Meanwhile, when the configuration information corresponding to the group to which the VM belongs does not exist in the configuration information DB 40b (step S702: No), the configuration updating unit 40c transmits a configuration information acquisition request of the group to the NW management server 5 (step S705).

When the configuration information of the corresponding group is received (step S706: Yes), the configuration updating unit 40c uses an identifier to identify the group as a search key and stores the received configuration information in the configuration information DB 40b (step S707). Next, the configuration updating unit 40c activates newly stored configuration information (step S708). At this time, the configuration updating unit 40c stores a record of “an identifier of an added configuration group, a MAC address of an added VM, and a number of members=0” in the group management DB. After the configuration information is activated, the configuration updating unit 40c increments the number of members in the group to which the activated configuration belongs, and transmits a response message indicating that the configuration information is completely stored to the physical server B 30.

In step S701, when the event type is not the running start (step S701: No), the configuration updating unit 40c determines whether the event type is the pause (step S709).

When the event type is the pause (step S709: Yes), the configuration updating unit 40c specifies a group to which the paused VM belongs from the group management DB, and decrements the number of members (step S710). Next, the configuration updating unit 40c determines whether the number of members is 0 as the decremented result of the number of members (step S711).

When the number of members is 0 (step S711: Yes), the configuration updating unit 40c refers to the configuration information DB 40b and invalidates or deletes the configuration information corresponding to the VM (step S712). Then, the configuration updating unit 40c transmits a response message indicating that the invalidation of the configuration information is completed to the physical server B 30 (step S704). Meanwhile, when the number of members is not 0 (step S711: No), the configuration updating unit 40c transmits a response message indicating that the configuration information is registered to the physical server B 30 (step S704).

In step S709, when the event type is not the pause (step S709: No), the configuration updating unit 40c determines whether the event type is the running completion (step S713). When the event type is the running completion (step S713: Yes), the configuration updating unit 40c transmits a response message to the physical server B 30 (step S704). When the event type is not the running completion (step S713: No), the configuration updating unit 40c ends the process.

According to the third embodiment, since the configuration information does not need to be managed for each VM, the amount of configuration information to be managed can be decreased. Since the configuration setting can be executed for each VM group, the management cost can be decreased.

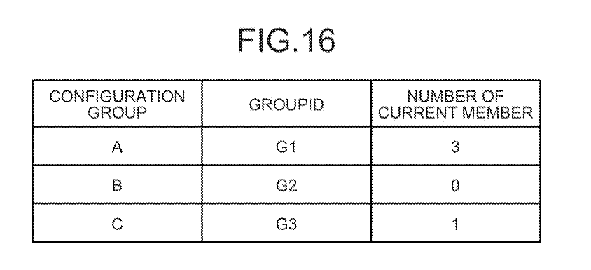

In the third embodiment, the example of the case where the determination of the group to which the VM belongs is executed in the physical switch side is described, but the present invention is not limited thereto. For example, in the case where the group to which the VM belongs is previously determined in the physical server side, when the VM information notifying unit of the physical server notifies the VM information notification message, the VM information notifying unit may notify a group identifier of the VM as the VM identifier. This case can be realized by including the group management DB illustrated in FIG. 16 in the physical server. FIG. 16 illustrates another example of the group management DB where the configuration information according to the third embodiment is grouped and stored. In the case of this example, when the VM information notifying unit of the physical server notifies the VM information notification message, the VM information notifying unit notifies GroupID as the VM identifier.

### [d] Fourth Embodiment

In the first embodiment, the example of the case where the state change of the VM is detected by monitoring the VM information DB is described, but the present invention is not limited thereto. For example, the state change of the VM may be detected by monitoring a port of the virtual switch.

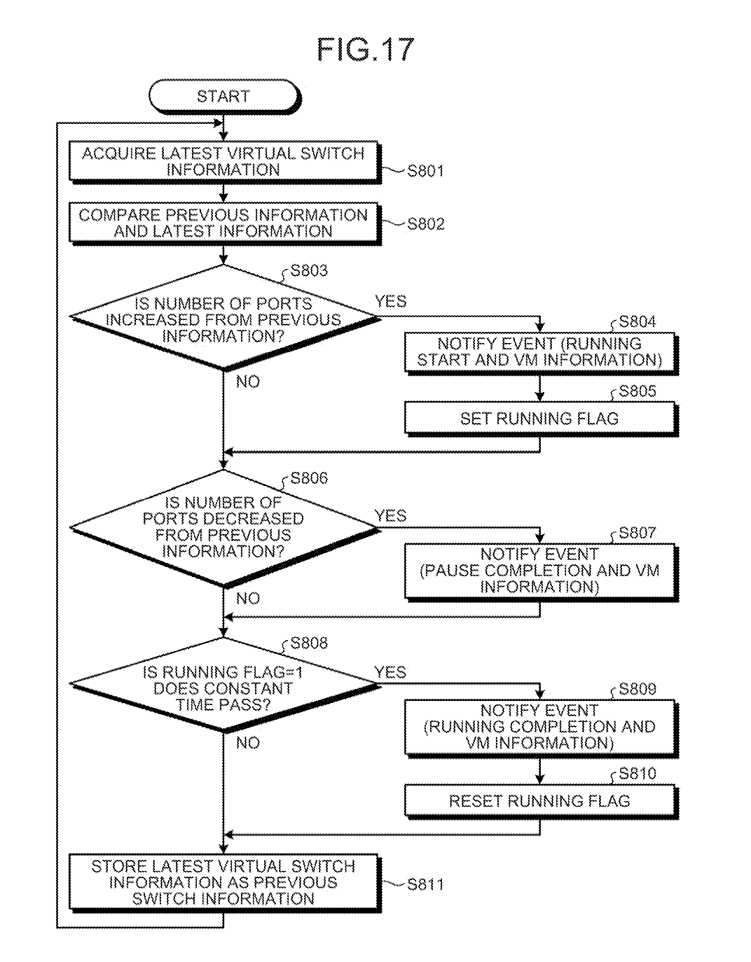

In a fourth embodiment, an example of the case where the state change of the VM is detected by monitoring the port of the virtual switch will be described using FIG. 17. In the fourth embodiment, an example of the case where the physical switch B 40 executes detection of the state change of the VM will be described.

FIG. 17 is a flowchart illustrating a flow of a VM monitoring process according to the fourth embodiment. As illustrated in FIG. 17, the VM state monitoring unit 34d of the physical server B 30 refers to a virtual switch 34b to acquire latest switch connection information (step S801), and compares the acquired switch connection information with the previous information stored in the memory (step S802).

When a number of ports increases from the previous information (step S803: Yes), the VM state monitoring unit 34d notifies the VM information notifying unit 34e of event information indicating “an event type=running start and a VM identifier=a MAC address of the added VM” (step S804). Then, the VM state monitoring unit 34d sets a “running flag=1” to a predetermined storage unit and recognizes that the VM is running or is being moved (step S805). The MAC address of the increased port is set by accessing to the VM control unit by the VM state monitoring unit 34d and acquiring a MAC address value of the port. For example, the MAC address value can be acquired from the migration process or the VM running process executed by the VM control unit 34c.

Meanwhile, when the number of ports is not increased from the previous information (step S803: No), the VM state monitoring unit 34d determines whether the number of ports is decreased from the previous information (step S806). When the port is deleted from the previous information (step S806: Yes), the VM state monitoring unit 34d notifies the VM information notifying unit 34e of event information indicating “an event type=pause completion and a VM identifier=a MAC address of the paused VM” (step S807). The MAC address of the paused VM, that is, the MAC address of the deleted VM can be acquired from the migration process or the VM deleting process executed by the VM control unit 34c. The VM state monitoring unit 34d may store the MAC address of the VM that is connected to the virtual switch 34b, whenever information is acquired from the virtual switch 34b.

Meanwhile, when the port is not deleted from the previous information (step S806: No), the VM state monitoring unit 34d determines whether a predetermined time passes from “running flag=1” (step S808). When the predetermined time passes from “running flag=1” (step S808: Yes), the VM state monitoring unit 34d notifies the VM information notifying unit 34e of event information indicating “an event type=running completion and a VM identifier=a MAC address of the VM where the predetermined time passes” (step S809). Then, the VM state monitoring unit 34d rests the “running flag” to “0” in the predetermined storage unit and recognizes that the running of the VM is completed (step S810).

When the predetermined time does not pass from “running flag=1” (step S808: No), the VM state monitoring unit 34d stores the latest VM information as the previous VM information in the predetermined storage unit such as the memory (step S811), returns to step S801, and repeats the following processes. Thereby, even in the case where an application programming interface (API) of a VM monitor is not opened or the case where the VM state cannot be monitored due to some circumstances, the running and the pause of the VM can be monitored.

### [e] Fifth Embodiment

In the first embodiment, the example of the case where the physical switch of the movement destination acquires the configuration information of the VM from the NW management server is described, but the present invention is not limited thereto. For example, the physical switch of the movement destination can acquire the configuration information of the VM from the movement source switch where the physical server of the movement source is accommodated. Thereby, the load of the NW management server that collectively manages the configuration information can be alleviated.

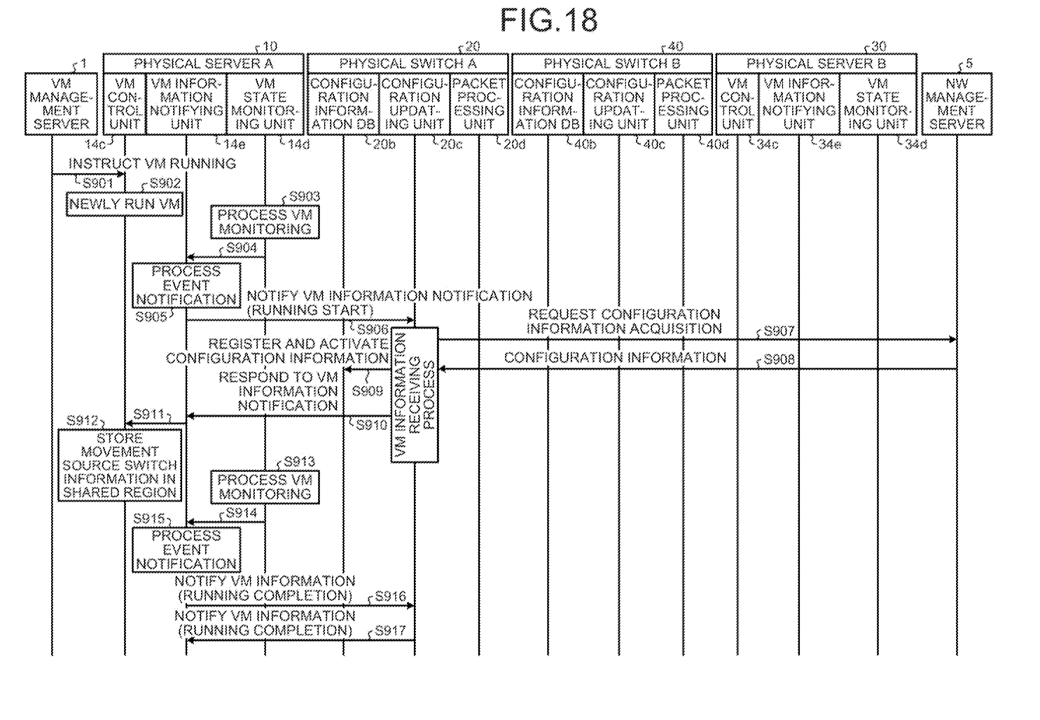

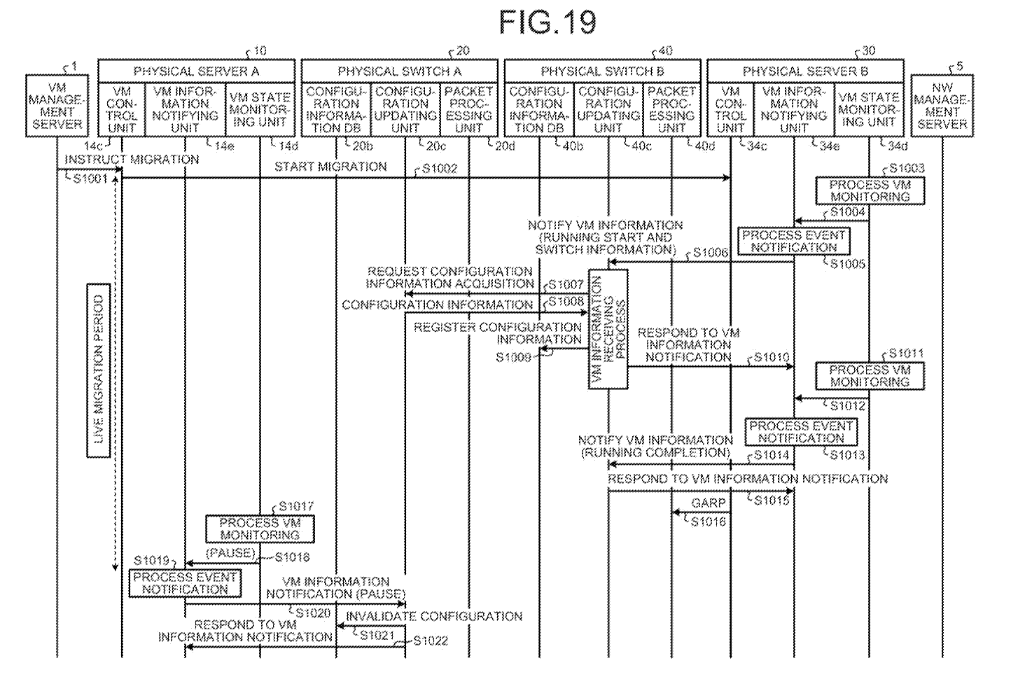

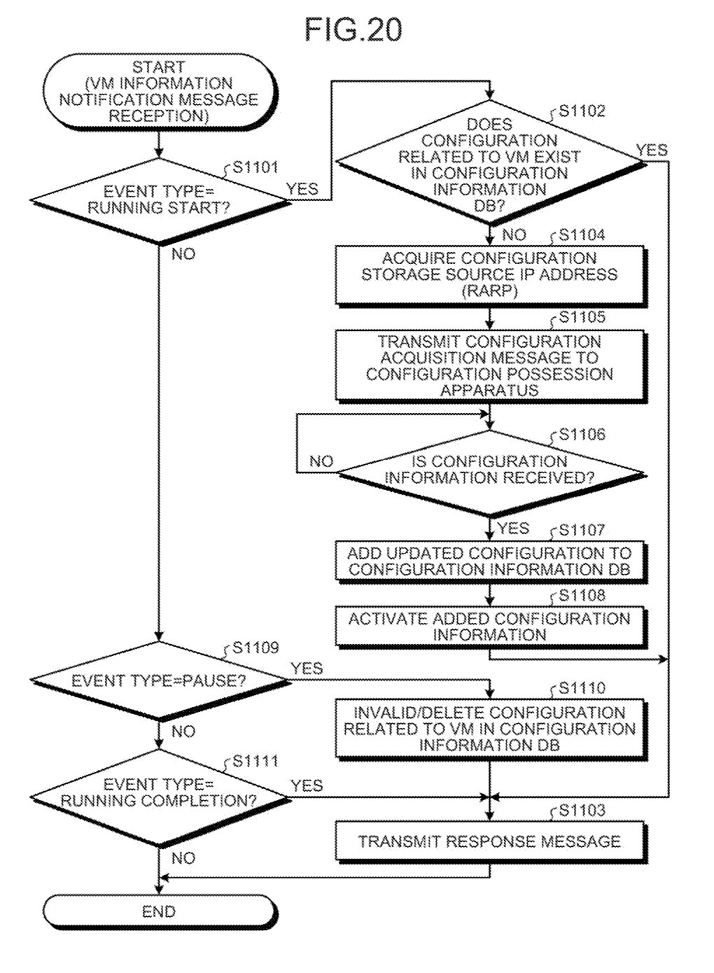

In this case, the movement source server needs to store the information of the physical switch that stores the configuration information of the run VM. Therefore, in a fifth embodiment, an operation sequence of when the VM is newly run and an operation sequence of when the live migration is executed will be described respectively using FIGS. 18 to 20. FIG. 18 illustrates an operation sequence of when a VM is newly run in a system according to the fifth embodiment. FIG. 19 illustrates an operation sequence of when the live migration is executed in the system according to the fifth embodiment. FIG. 20 is a flowchart illustrating a flow of a VM information receiving process according to the fifth embodiment.

The fifth embodiment is different from the first embodiment in that the VM information DB included in each physical server has a shared file region shared by all of the physical servers. The shared file region can be referred to by all of the physical servers.

Operation Sequence of when the VM is Newly Run

As illustrated in FIG. 18, the VM control unit 14c of the physical server A 10 that receives a new running instruction of the VM from the VM management server 1 runs the designated VM (steps S901 and S902). For example, the VM control unit 14c generates a record where a MAC address of the VM is used as a search key in the VM information DB 14a or connects the VM to the virtual switch 14b.

The VM state monitoring unit 14d of the physical server A 10 executes the VM monitoring process and detects that the new VM is stored in the VM information DB 14a (step S903). The VM state monitoring unit 14d notifies the VM information notifying unit 14e that the VM is added to the VM information DB 14a (step S904).

Next, the VM information notifying unit 14e of the physical server A 10 executes the event notifying process and generates a VM information notification message to notify the new running start of the VM (step S905). The VM information notifying unit 14e transmits the generated VM information notification message to the physical switch A 20 (step S906).

The configuration updating unit 20c of the physical switch A 20 executes a VM information receiving process. Specifically, the configuration updating unit 20c acquires a MAC address of the VM that is included in the received VM information notification message to notify the running start of the VM, and transmits a configuration information acquisition request corresponding to the MAC address to the NW management server 5 (step S907). The NW management server 5 that receives the request transmits configuration information of the VM corresponding to the MAC address included in the request to the physical switch A 20 as a response (step S908). Next, the configuration updating unit 20c uses the MAC address of the VM as a search key, stores the received configuration information in the configuration information DB 20b, and activates the configuration information (step S909). Next, the configuration updating unit 20c transmits a response, which indicates that the registration and activation of the configuration information end, to the physical server A 10 (step S910).

Next, the VM information notifying unit 14e of the physical switch A 20 acquires the MAC address of the physical switch A 20 from the response received from the physical switch A 20, and notifies the VM control unit 14c of the acquired MAC address (step S911). Next, the VM control unit 14c associates the MAC address of the newly run VM and the MAC address of the physical switch A 20 with each other and stores the association result in the shared file region (step S912).

For example, the VM information notifying unit 14e determines a Source MAC address of the VM information response message as an address of a configuration possession device that possesses the configuration information of the corresponding VM, associates the Source MAC address with a VM identifier, and stores the association result in the shared file region of the VM information DB 14a. Since the shared file region is stored in a disk region shared by all of the physical servers, the DB can be referred to by all of the physical servers.

Then, the VM state monitoring unit 14d of the physical server A 10 executes the VM monitoring process and detects that the new running of the VM is completed (step S913). The VM state monitoring unit 14d notifies the VM information notifying unit 14e that the running is completed (step S914).

Next, the VM information notifying unit 14e of the physical server A 10 executes the event notifying process and generates a VM information notification message to notify the running completion of the VM (step S915). The VM information notifying unit 14e transmits the generated VM information notification message to the physical switch A 20 (step S916).

Next, the configuration updating unit 20c of the physical switch A 20 transmits a response to the received VM information notification message to the physical server A 10 (step S917). As a result, the new VM running in the physical server A 10 is completed.

Operation Sequence of when the Live Migration is Executed

As illustrated in FIG. 19, the VM management server 1 transmits a start instruction of live migration control to the physical server A 10 (step S1001). The VM control unit 14c of the physical server A 10 starts the live migration control of the VM between the VM control unit 34c of the physical server B 30 and the VM control unit 14c (step S1002). At this time, the VM control unit 34c of the physical server B 30 generates a record of the VM as the movement object in the VM information DB 34a.

Next, the VM state monitoring unit 34d of the physical server B 30 executes the VM monitoring process and detects that the live migration of the VM has started (step S1003). The VM state monitoring unit 34d notifies the VM information notifying unit 34e that the VM is added to the VM information DB 34a (step S1004).

Next, the VM information notifying unit 34e of the physical server B 30 executes the event notifying process and generates a VM information notification message to notify the running start of the VM (step S1005). The VM information notifying unit 34e transmits the generated VM information notification message to the physical switch B (step S1006). At this time, the VM information notifying unit 34e accesses to the shared file region of the VM information DB 14a that is shared by all of the physical servers, and acquires a VM identifier and a configuration possession device address. The VM information notifying unit 34e transmits a VM information notification message that includes the running start event, the VM identifier, and the configuration possession device address.

The configuration updating unit 40c of the physical switch B 40 executes the VM information receiving process. Specifically, the configuration updating unit 40c acquires a VM identifier (a MAC address of the VM) and a configuration possession device address that are included in the received VM information notification message to notify the running start of the VM. The configuration updating unit 40c transmits a configuration information acquisition request corresponding to the MAC address of the VM to the physical switch A 20 having the configuration possession device address (step S1007).

The configuration updating unit 20c of the physical switch A 20 that receives the request transmits configuration information of the VM corresponding to the MAC address included in the request to the physical switch B 40 as a response (step S1008).

Next, the configuration updating unit 40c of the physical switch B 40 uses the MAC address of the VM as a search key, stores the received configuration information in the configuration information DB 40b, and activates the configuration information (step S1009). Next, the configuration updating unit 40c transmits a response, which indicates that the registration and activation of the configuration information end, to the physical server B 30 (step S1010).

Next, the VM state monitoring unit 34d of the physical server B 30 executes the VM monitoring process and detects that the live migration of the VM is completed (step S1011). The VM state monitoring unit 34d notifies the VM information notifying unit 34e that the live migration is completed (step S1012).

Next, the VM information notifying unit 34e of the physical server B 30 executes the event notifying process and generates a VM information notification message to notify the running completion of the VM (step S1013). The VM information notifying unit 34e transmits the generated VM information notification message to the physical switch B 40 (step S1014).

Next, the configuration updating unit 40c of the physical switch B 40 transmits a response to the received VM information notification message to the physical server B 30 (step S1015). As a result, the VM control unit 34c of the physical server B 30 transmits the GARP to the physical switch B 40 (step S1016).

As described above, the process is executed by the movement destination side, and the VM state monitoring unit 14d of the physical server A 10 of the movement source executes the VM monitoring process and detects that the live migration of the VM starts and the VM is paused (step S1017). The VM state monitoring unit 14d notifies the VM information notifying unit 14e that the VM stored in the VM information DB 14a is paused (step S1018).

Next, the VM information notifying unit 14e of the physical server A 10 executes the event notification process and generates a VM information notification message to notify the pause of the VM (step S1019). The VM information notifying unit 14e transmits the generated VM information notification message to the physical switch A (step S1020).

The configuration updating unit 20c of the physical switch A 20 refers to the configuration information DB 20b and invalidates configuration information where the MAC address of the VM included in the received message is used as a search key (step S1021). Next, the configuration updating unit 20c transmits a response indicating that the invalidation of the configuration information ends to the physical server A 10 (step S1022).

Flow of the VM Information Receiving Process

Next, a flow of the VM information receiving process illustrated in FIG. 18 will be described. In this case, an example of the case where the physical switch B 40 executes the VM information receiving process will be described.

As illustrated in FIG. 20, the configuration updating unit 40c of the physical switch B 40 that receives the information notification message from the physical server B 30 determines whether an event type of the received message is the running start (step S1101).

When the event type is the running start (step S1101: Yes), the configuration updating unit 40c determines whether configuration information corresponding to the VM exists in the configuration information DB 40b (step S1102). For example, the configuration updating unit 40c determines whether configuration information corresponding to a VM identifier of the received message is stored.

When the configuration information corresponding to the VM exists in the configuration information DB 40b (step S1102: Yes), the configuration updating unit 40c transmits a response message to the physical server B 30 (step S1103).

Meanwhile, when the configuration information corresponding to the VM does not exist (step S1102: No), the configuration updating unit 40c acquires an IP address of the configuration possession device by RARP (step S1104). For example, the configuration updating unit 40c acquires the IP address of the configuration possession device by RARP where the MAC address of the configuration possession device included in the received VM information notification message is used as a search key. The process of Step S1104 is executed in the case where the physical switch mounts an apparatus of a layer 3. Next, the configuration updating unit 40c transmits a configuration information acquisition request of the VM to the configuration possession apparatus (step S1105).

When the configuration information of the VM is received (step S1106: Yes), the configuration updating unit 40c uses a MAC address of the VM as a search key and stores the received configuration information in the configuration information DB 40b (step S1107). Next, the configuration updating unit 40c activates newly stored configuration information (step S1108) and transmits a response message indicating that the configuration information is completely stored to the physical server B 30 (step S1103).

In step S1101, when the event type is not the running start (step S1101: No), the configuration updating unit 40c determines whether the event type is the pause (step S1109).

When the event type is the pause (step S1109: Yes), the configuration updating unit 40c refers to the configuration information DB 40b and invalidates or deletes the configuration information corresponding to the VM (step S1110). Next, the configuration updating unit 40c transmits a response message indicating that the invalidation of the configuration information is completed to the physical server B 30 (step S1103).

Meanwhile, when the event type is not the pause (step S1109: No), the configuration updating unit 40c determines whether the event type is the running completion (step S1111). When the event type is the running completion (step S1111: Yes), the configuration updating unit 40c transmits a response message to the physical server B 30 (step S1103). When the event type is not the running completion (step S1111: No), the configuration updating unit 40c ends the process.

In the fifth embodiment, when the VM is registered, the physical server A 10 may store the address of the physical switch A 20 that possesses the configuration information. However, the physical server A 10 may possess the configuration information of the VM as a registration object. Thereby, similar to the fifth embodiment, the load of the NW management server 5 that collectively manages the configuration information can be alleviated.

### [e] Sixth Embodiment

In the first to fifth embodiments, the physical switch network has the one-step configuration. However, the present invention may be applied to a network having the multi-step configuration.

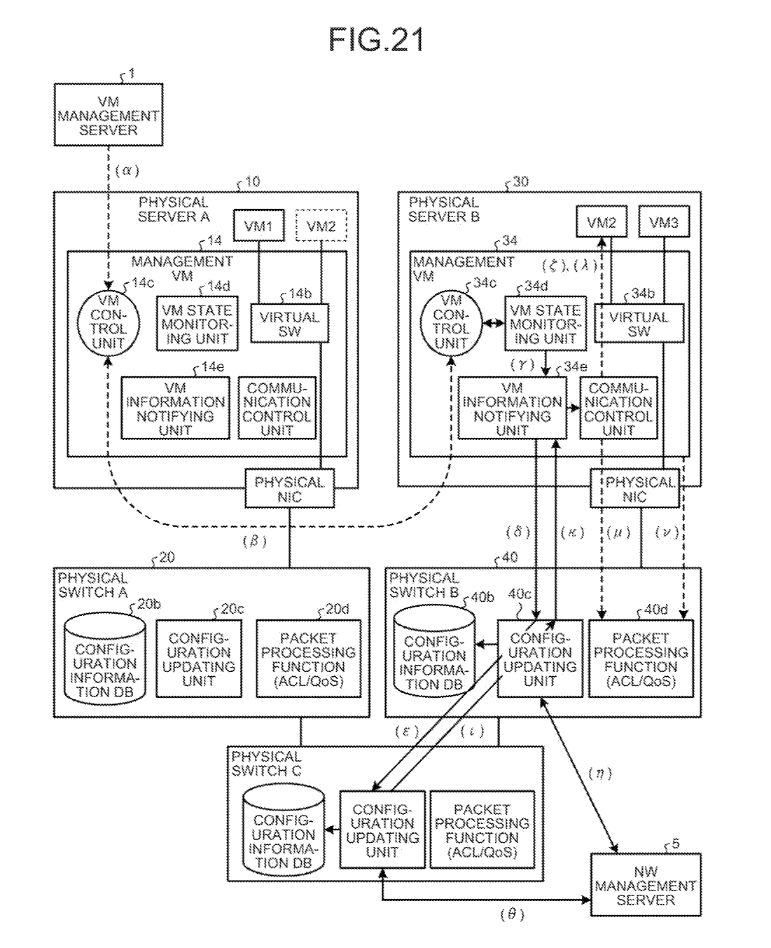

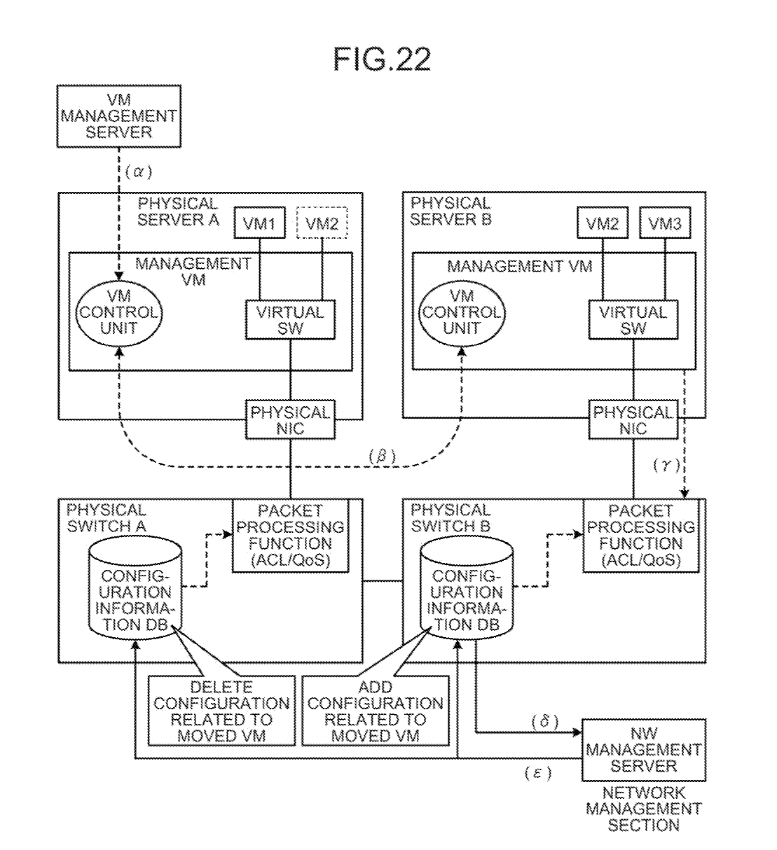

Therefore, in a sixth embodiment, an example of the case where the live migration is executed in a network in which physical switches are configured in multi-steps will be described using FIG. 21. FIG. 21 illustrates an example of the case where the live migration is executed in the network in which the physical switches are configured in multi-steps. The entire configuration illustrated in FIG. 21 has the multi-step configuration where the physical switch C is connected to each of the physical switch A 20 and the physical switch B 40, in addition to the configuration illustrated in FIG. 1.

In this configuration, an example of the case where the VM2 running on the physical server A 10 is live migrated to the physical server B 30 will be described. FIG. 21 illustrates an example of live migration according to the sixth embodiment.

As illustrated in FIG. 21, the VM control unit 14c of the physical server A 10 receives a live migration instruction of the VM2 from the VM management server 1 (refer to (α) of FIG. 21). The VM control unit 14c of the physical server A 10 starts live migration control of the VM2 between the VM control unit 34c of the physical server B 30 and the VM control unit 14c (refer to (β) of FIG. 21). At this time, the VM control unit 34c of the physical server B 30 generates a record of the VM2 in the VM information DB 34a that is not illustrated in FIG. 21.

The VM state monitoring unit 34d of the physical server B 30 detects that the record of the VM2 is added to the VM information DB 34a and notifies the VM information notifying unit 34e that the VM2 is added (refer to (γ) of FIG. 21). Next, the VM information notifying unit 34e of the physical server B 30 that receives the notification of the addition of the VM2 from the VM state monitoring unit 34d generates a VM information notification message of an event type “movement” including the MAC address of the added VM2 and transmits the VM information notification message to the physical switch B 40 (refer to (δ) of FIG. 21). Next, the configuration updating unit 40c of the physical switch B 40 transmits the received VM information notification message of the event type “movement” to the physical switch C (refer to (ε) of FIG. 21).

At this time, the VM information notifying unit 34e of the physical server B 30 notifies the VM information notification message with a packet using a multicast address or a broadcast address as a destination to notify all of the network devices of the VM information notification message. At this time, instead of the multicast packet or the broadcast packet, a unicast address packet may be transmitted, and the physical switch that receives the unicast address packet may relay the unicast address packet to the adjacent switch.

Next, the communication control unit of the physical server B30 issues a read pause instruction of the packet to the running VM and pauses packet transmission of the VM (refer to (ξ) of FIG. 21). The read pause instruction may cause a PAUSE frame to be transmitted to the VM or scheduling of the VM on the management VM 34 to be paused. When the communication control unit of the physical server B 30 receives a response message of a running start event notification from the physical switch B 40 or the physical switch C, the communication control unit may issue a read pause instruction of the packet to the running VM.

Next, the configuration updating unit 40c of the physical switch B 40 transmits a configuration acquisition request including the MAC address of the VM2 during the movement to the NW management server 5, receives configuration of the VM2, stores the configuration in the configuration information DB 40b, and activates the configuration (refer to (η) of FIG. 21). Likewise, the physical switch C transmits a configuration acquisition request including the MAC address of the VM2 during the movement to the NW management server 5, receives configuration of the VM2, stores the configuration in the configuration information DB 40b, and activates the configuration (refer to (θ) of FIG. 21).

The physical switch C transmits information indicating that the activation of the configuration information is completed to the physical switch B 40 (refer to (τ) of FIG. 21). Next, the physical switch B 40 transmits information indicating that the self device and the physical switch C complete the activation of the configuration information to the physical server B 30 (refer to (κ) of FIG. 21).

As a result, the communication control unit of the physical server B 30 releases the read pause instruction of the packet with respect to the running VM (refer to (λ) of FIG. 21). Likewise, the communication control unit of the physical server B 30 transmits a notification indicating that a packet process with respect to the running VM is enabled to the physical server B 30, and releases the packet process with respect to the running VM (refer to (μ) of FIG. 21). The read pause releasing instruction or the transmission releasing instruction may cause the PAUSE frame to be transmitted to the VM or scheduling of the VM on the management VM 34 to start.

Then, if the live migration is completed, the packet processing unit 40d of the physical switch B 40 receives a GARP packet from the physical server B 30 and recognizes that the live migration is completed (refer to (γ) of FIG. 21).

As such, in an environment where the switches are configured in multi-steps, a long time is needed until the physical server of the movement destination detects the state change of the VM, the state change is notified to the physical switch of the first step, and configuration information of all of the physical switches is updated. For this reason, even though communication of the VM restarts at a point of time when setting of the switch of the first step is completed, end-to-end communication cannot be performed.

Therefore, if the above-described processes are executed, unnecessary packet transmission from the virtual switch can be avoided until setting of all of the multi-step switches is completed, and the processing load of the management VM can be alleviated. Since the packet loss is avoided, a bad effect is not given to an application on the VM. Even when the GARP issued by the management VM is issued during the update of the configuration information of the physical switch and is discarded by the physical switch, the GARP packet is transmitted after setting of the configuration information of all of the physical switches is completed. Therefore, normal packet relay is performed.

### [f] Seventh Embodiment

The embodiments of the present invention are described. However, the present invention can be realized by a variety of different embodiments, in addition to the above-described embodiments. Therefore, the different embodiments will be described below.

Activation Timing

For example, in the first embodiment, the physical switch activates the configuration information immediately after the physical switch acquires the configuration information from the VM management server and registers the configuration information in the configuration information DB, but the present invention is not limited thereto. For example, the physical switch may activate the configuration information, when a message indicating the VM running completion event is received from the physical server. Thereby, setting of the physical switch can be changed only when the live migration or the running of the VM is securely completed, and unnecessary setting can be avoided from being given to the physical server when the live migration or the running is failed.

Acquisition Destination of the Configuration Information

For example, in the fifth embodiment, the address of the configuration possession apparatus or the configuration information that is acquired from the movement source switch is stored in the shared file region that is shared by all of the servers. However, the address or the configuration information may be notified from the movement source server to the movement destination server using a different protocol.

Specifically, when the movement source server receives the VM information notification response message from the movement source switch, the address of the configuration possession device or the configuration information that is included in the received VM information notification response message is stored in a local configuration DB. In addition, the movement source server monitors a control interface from the VM management server. When a live migration running start instruction is issued, the movement source server snoops the VM information notification response message and acquires a physical server address of the movement destination and information of the VM as the movement object.

Next, the movement source server acquires the address of the configuration possession device or the configuration information from the local configuration DB and transmits the address of the configuration information possession device or the configuration information to the physical server of the movement destination. Then, when the running start event of the VM is detected, the movement destination server transmits the VM information notification message, which is notified from the movement source server and includes the address of the configuration information possession device or the configuration information, to the movement destination server.

When the information included in the VM information notification message is the configuration information, the configuration information that is received by the movement destination switch is stored in the configuration information DB. When the information included in the VM information notification message is the address of the configuration possession device, the movement destination switch transmits the configuration acquisition request message to the movement source switch, acquires the configuration information, and stores the configuration information in the configuration information DB. Thereby, even in an environment where there is no disk region that is shared by all of the physical servers, the configuration information can be notified.

Acquisition Timing of the Configuration Information

In the above-described embodiments, when the virtual machine is registered, the configuration information is acquired from the physical switch. However, when the live migration starts, the configuration information may be acquired from the physical switch.

Specifically, the movement source server monitors the control interface from the VM management server. When a live migration running start instruction is issued, the movement source server snoops the VM information notification response message and acquires a physical server address of the movement destination and information of the VM as the movement object. The movement source server transmits the configuration acquisition request message to the adjacent physical switch (movement source physical switch), acquires the configuration information of the corresponding VM, and transmits the configuration information to the physical server of the movement destination. Then, when the running start event of the VM is detected, the movement destination server transmits the VM information notification message, which is notified from the movement source server and includes the configuration information, to the movement destination switch. The movement destination switch stores the received configuration information in the configuration information DB.

System

All or part of the processes that are described as being automatically executed among the processes described in the embodiments may be manually executed. Alternatively, all or part of the processes that are described as being manually executed may be automatically executed using a known method. In addition, the processing sequences, the control sequences, the specific names, and the information including the variety of data or parameters that are illustrated in the specification and the drawings may be arbitrarily changed, except for the case where special mentions are given.

The components of the individual devices that are illustrated in the drawings are functional and conceptual, and do not need to be physically configured as illustrated in the drawings. That is, the specific forms of separation and/or integration of the devices such as integration of the VM control unit 14c and the VM state monitoring unit 14d are not limited to the forms illustrated in the drawings. All or part of the devices may be configured to be functionally or physically separated and/or integrated in an arbitrary unit according to the various loads or use situations. All or part of the processing functions that are executed in the individual devices may be realized by a CPU and a program analyzed and executed by the CPU, or may be realized as hardware based on wired logic.

Program

The control method that is described in the embodiments may be realized by executing a prepared program by a computer such as a personal computer or a workstation. This program may be distributed through a network such as the Internet. This program may be recorded in a computer readable recording medium such as a hard disk, a flexible disk (FD), a CD-ROM, an MO, and a DVD and may be executed by reading the program from the recording medium by the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer, comprising:
a monitoring unit that monitors a state of a virtual machine running on the computer; and
a state transmitting unit that transmits, in response to detection of a change in the state of the virtual machine, information including a content of the state change of the virtual machine to a communication device to control communication between the computer and another computer.

2. The computer according to claim 1, further comprising:
a virtual information storage unit that stores information of the virtual machine running on the computer,
wherein the monitoring unit monitors the state of the virtual machine running on the computer, based on the information of the virtual machine stored in the virtual information storage unit.

3. The computer according to claim 1, further comprising:
a virtual machine switch unit that controls communication between the virtual machine and the another computer or another virtual machine,
wherein the monitoring unit monitors the state of the virtual machine running on the computer, based on a connection situation of the virtual machine switch unit.

4. The computer according to claim 1,
wherein the monitoring unit detects migration where the virtual machine is moved from another computer, based on the change in the state of the virtual machine running on the computer, and
wherein the state transmitting unit transmits a virtual machine identifier to specify the virtual machine as a migration object to the communication device.

5. The computer according to claim 1,
wherein the monitoring unit detects migration where the virtual machine is moved from another computer, based on the change in the state of the virtual machine running on the computer, and
wherein the state transmitting unit acquires address information of a movement source physical switch to which another computer corresponding to a movement source of the virtual machine as the migration object is connected from the another computer, and transmits a virtual machine identifier to specify the virtual machine as the migration object and the address information of the movement source physical switch to the communication device.

6. The computer according to claim 1,
wherein the monitoring unit detects migration where the virtual machine is moved from another computer, based on the change in the state of the virtual machine running on the computer, and
wherein the state transmitting unit acquires configuration information of the virtual machine as the migration object from another device corresponding to a movement source of the virtual machine as the migration object, and transmits a virtual machine identifier to specify the virtual machine as the migration object and the configuration information of the virtual machine to the communication device.

7. A computer, comprising:
a processor configured to execute a procedure, the procedure comprising:
monitoring a state of a virtual machine running on the computer; and
transmitting, in response to detection of a change in the state of the virtual machine, information including a content of the change in the state of the virtual machine to a communication device to control communication between the computer and another computer.

8. A computer-readable, non-transitory medium storing a program that causes a computer to execute a process comprising:
monitoring a state of a virtual machine running on the computer; and
transmitting, in response to detection of a change in the state of the virtual machine, information including a content of the change in the state of the virtual machine to a communication device to control communication between the computer and another computer.

9. The computer-readable, non-transitory medium according to claim 8,
wherein the information includes identification information of the virtual machine.

10. The computer-readable, non-transitory medium according to claim 8, wherein the monitoring includes monitoring the state of the virtual machine running on the computer, based on a connection situation of a virtual machine switch unit that controls communication between the virtual machine and the another computer or another virtual machine.

11. A communication device, comprising:
a storage unit that stores configuration information of a virtual machine running on a computer connected to the communication device;
an information updating unit that receives VM information of the virtual machine from the computer, in response to a change in a state of the virtual machine, and updates the configuration information stored in the storage unit, based on the VM information; and
a control unit that controls communication of the computer and another communication device or another computer, based on the configuration information stored in the storage unit.

12. The communication device according to claim 11,
wherein, when a virtual machine identifier to specify a virtual machine as a migration object is received from the computer, the information updating unit acquires configuration information corresponding to the virtual machine identifier from a management device that manages the configuration of the virtual machine, and stores the configuration information in the storage unit.

13. The communication device according to claim 11, wherein, when the information updating unit receives a virtual machine identifier to specify a virtual machine as a migration object and address information of a movement source physical switch accommodating another computer corresponding to a movement source of the virtual machine as the migration object, from the computer, the information updating unit acquires an configuration information corresponding to the virtual machine identifier from the movement source physical switch and stores the configuration information in the storage unit.

14. The communication device according to claim 11, wherein, when the information updating unit receives a virtual machine identifier to specify a virtual machine as a migration object and configuration information of the virtual machine as the migration object, from the computer, the information updating unit stores the received configuration information in the storage unit.

15. A communication device, comprising:
a storage unit that stores configuration information of a virtual machine running on a computer connected to the communication device;
a processor configured to execute a procedure, the procedure comprising:
receiving VM information of the virtual machine from the computer, in response to a change in a state of the virtual machine, and updates the configuration information stored in the storage unit, based on the VM information; and
controlling communication of the computer and another communication device or another computer, based on the configuration information stored in the storage unit.

16. A computer-readable, non-transitory medium storing a communication program that causes a computer to execute a process comprising:
receiving VM information of a virtual machine from a computer in response to a change in a state of the virtual machine to update configuration information stored in a storage unit to store the configuration information of the virtual machine running on the computer connected to a communication device, based on the VM information; and
controlling communication of the computer and another communication device or another computer, based on the configuration information stored in the storage unit.

17. A communication control system comprising:
a computer to run a virtual machine; and
a communication device connected to the computer, wherein
the computer includes
a monitoring unit that monitors a state of the virtual machine running on the computer, and
a transmitting unit that transmits information including a content of the change in the state of the virtual machine to the communication device to control communication between the computer and another computer, in response to detection of a change in the state of the virtual machine, and
the communication device includes
a storage unit that stores configuration information of the virtual machine running on the computer connected to the communication device,
an information updating unit that receives information including a content of the change in the state of the virtual machine from the computer, in response to the change in the state of the virtual machine; and
updating the configuration information stored in the storage unit, based on the information, and
a control unit that controls communication of the computer and another communication device or another computer, based on the configuration information stored in the storage unit.

18. A communication method suitable for a communication control system having a computer to run a virtual machine and a communication device connected to the computer, the communication method comprising:
causing the computer to monitor a state of the virtual machine running on the computer;
causing the computer to transmit information including a content of a change in the state of the virtual machine to the communication device to control communication between the computer and another computer, in response to detection of the change in the state of the virtual machine;
causing the communication device to receive information including a content of the change in the state of the virtual machine from the computer, when the state of the virtual machine is changed, to update configuration information stored in a storage unit storing the configuration information of the virtual machine running on the computer connected to the communication device, based on the information; and
causing the communication device to control communication between the computer and another communication device or another computer, based on the configuration information stored in the storage unit.
